(19) United States
(12) Patent Application Publication
(10) Pub. No.: US 2025/0031084 A1
(43) Pub. Date: Jan. 23, 2025

(54) FORMATS FOR INDICATING BEAM INDICES

(71) Applicant: QUALCOMM Incorporated, San Diego, CA (US)

(72) Inventors: Tianyang BAI, Mountain View, CA (US); Hua WANG, Basking Ridge, NJ (US); Junyi LI, Greentown, PA (US); Tao LUO, San Diego, CA (US)

(21) Appl. No.: 18/761,400

(22) Filed: Jul. 2, 2024

Related U.S. Application Data
(60) Provisional application No. 63/514,275, filed on Jul. 18, 2023.

(51) Int. Cl. H04W 24/10; H04L 5/00

(52) U.S. Cl. CPC H04W 24/10; H04L 5/0048

(57) ABSTRACT

Various aspects of the present disclosure generally relate to wireless communication. In some aspects, a user equipment (UE) may receive, from a network node, configuration information indicating that the UE is to measure N reference signals and report K reference signals, wherein N and K are integers. The UE may transmit, to the network node, a measurement report indicating a combination index associated with K selected reference signals of the N reference signals and measurement values for the K selected reference signals. Numerous other aspects are described.

### CROSS-REFERENCE TO RELATED APPLICATION

This patent application claims priority to U.S. Provisional Patent Application No. 63/514,275, filed on Jul. 18, 2023, entitled “FORMATS FOR INDICATING BEAM INDICES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for reducing overhead associated with indicating beam indices.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories, one or more processors coupled to the one or more memories, and instructions stored in the one or more memories and executable by the one or more processors. The instructions may be executable by the one or more processors to cause the UE to receive, from a network node, configuration information indicating that the UE is to measure N reference signals and report K reference signals, wherein N and K are integers. The instructions may be executable by the one or more processors to cause the UE to transmit, to the network node, a measurement report indicating a combination index associated with K selected reference signals of the N reference signals and measurement values for the K selected reference signals.

Some aspects described herein relate to a network node for wireless communication. The network node may include one or more memories, one or more processors coupled to the one or more memories, and instructions stored in the one or more memories and executable by the one or more processors. The instructions may be executable by the one or more processors to cause the network node to transmit, to a UE, configuration information indicating that the UE is to measure N reference signals and report K reference signals, wherein N and K are integers. The instructions may be executable by the one or more processors to cause the network node to receive, from the UE, a measurement report indicating a combination index associated with K selected reference signals of the N reference signals and measurement values for the K selected reference signals.

Some aspects described herein relate to a UE for wireless communication. The UE may include one or more memories, one or more processors coupled to the one or more memories, and instructions stored in the one or more memories and executable by the one or more processors. The instructions may be executable by the one or more processors to cause the UE to receive, from a network node, configuration information indicating that the UE is to measure N reference signals and report K reference signals, wherein N and K are integers. The instructions may be executable by the one or more processors to cause the UE to transmit, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a network node for wireless communication. The network node may include one or more memories, one or more processors coupled to the one or more memories, and instructions stored in the one or more memories and executable by the one or more processors. The instructions may be executable by the one or more processors to cause the network node to transmit, to a UE, configuration information indicating that the UE is to measure N reference signals and report K reference signals, wherein N and K are integers. The instructions may be executable by the one or more processors to cause the network node to receive, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a UE for wireless communication. The UE may include one or more memories, one or more processors coupled to the one or more memories, and instructions stored in the one or more memories and executable by the one or more processors. The instructions may be executable by the one or more processors to cause the UE to receive, from a network node, configuration information indicating a combination index that corresponds to N selected reference signals, from a set of M reference signals, to be measured by the UE, wherein N and M are integers. The instructions may be executable by the one or more processors to cause the UE to transmit, to the network node, a measurement report associated with measurements of the N selected reference signals.

Some aspects described herein relate to a network node for wireless communication. The network node may include one or more memories, one or more processors coupled to the one or more memories, and instructions stored in the one or more memories and executable by the one or more processors. The instructions may be executable by the one or more processors to cause the network node to transmit, to a UE, configuration information indicating a combination index that corresponds to N selected reference signals, from a set of M reference signals, to be measured by the UE, wherein N and M are integers. The instructions may be executable by the one or more processors to cause the network node to receive, from the UE, a measurement report associated with measurements of the N selected reference signals.

Some aspects described herein relate to a UE for wireless communication. The UE may include one or more memories, one or more processors coupled to the one or more memories, and instructions stored in the one or more memories and executable by the one or more processors. The instructions may be executable by the one or more processors to cause the UE to receive, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The instructions may be executable by the one or more processors to cause the UE to transmit, to the network node, a measurement report associated with measurements of the N selected reference signals.

Some aspects described herein relate to a network node for wireless communication. The network node may include one or more memories, one or more processors coupled to the one or more memories, and instructions stored in the one or more memories and executable by the one or more processors. The instructions may be executable by the one or more processors to cause the network node to transmit, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The instructions may be executable by the one or more processors to cause the network node to receive, from the UE, a measurement report associated with measurements of the N selected reference signals.

Some aspects described herein relate to a UE for wireless communication. The UE may include one or more memories, one or more processors coupled to the one or more memories, and instructions stored in the one or more memories and executable by the one or more processors. The instructions may be executable by the one or more processors to cause the UE to receive, from a network node, configuration information indicating one or more formats for indicating selected reference signals. The instructions may be executable by the one or more processors to cause the UE to communicate with the network node based at least in part on the one or more formats for indicating selected reference signals.

Some aspects described herein relate to a network node for wireless communication. The network node may include one or more memories, one or more processors coupled to the one or more memories, and instructions stored in the one or more memories and executable by the one or more processors. The instructions may be executable by the one or more processors to cause the network node to transmit, to a UE, configuration information indicating one or more formats for indicating selected reference signals. The instructions may be executable by the one or more processors to cause the network node to communicate with the UE based at least in part on the one or more formats for indicating selected reference signals.

Some aspects described herein relate to a method of wireless communication performed by a UE. The method may include receiving, from a network node, configuration information indicating that the UE is to measure N reference signals and report K reference signals, wherein N and K are integers. The method may include transmitting, to the network node, a measurement report indicating a combination index associated with K selected reference signals of the N reference signals and measurement values for the K selected reference signals.

Some aspects described herein relate to a method of wireless communication performed by a network node. The method may include transmitting, to a UE, configuration information indicating that the UE is to measure N reference signals and report K reference signals, wherein N and K are integers. The method may include receiving, from the UE, a measurement report indicating a combination index associated with K selected reference signals of the N reference signals and measurement values for the K selected reference signals.

Some aspects described herein relate to a method of wireless communication performed by a UE. The method may include receiving, from a network node, configuration information indicating that the UE is to measure N reference signals and report K reference signals, wherein N and K are integers. The method may include transmitting, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a method of wireless communication performed by a network node. The method may include transmitting, to a UE, configuration information indicating that the UE is to measure N reference signals and report K reference signals, wherein N and K are integers. The method may include receiving, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a method of wireless communication performed by a UE. The method may include receiving, from a network node, configuration information indicating a combination index that corresponds to N selected reference signals, from a set of M reference signals, to be measured by the UE, wherein N and M are integers. The method may include transmitting, to the network node, a measurement report associated with measurements of the N selected reference signals.

Some aspects described herein relate to a method of wireless communication performed by a network node. The method may include transmitting, to a UE, configuration information indicating a combination index that corresponds to N selected reference signals, from a set of M reference signals, to be measured by the UE, wherein N and M are integers. The method may include receiving, from the UE, a measurement report associated with measurements of the N selected reference signals.

Some aspects described herein relate to a method of wireless communication performed by a UE. The method may include receiving, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The method may include transmitting, to the network node, a measurement report associated with measurements of the N selected reference signals.

Some aspects described herein relate to a method of wireless communication performed by a network node. The method may include transmitting, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The method may include receiving, from the UE, a measurement report associated with measurements of the N selected reference signals.

Some aspects described herein relate to a method of wireless communication performed by a UE. The method may include receiving, from a network node, configuration information indicating one or more formats for indicating selected reference signals. The method may include communicating with the network node based at least in part on the one or more formats for indicating selected reference signals.

Some aspects described herein relate to a method of wireless communication performed by a network node. The method may include transmitting, to a UE, configuration information indicating one or more formats for indicating selected reference signals. The method may include communicating with the UE based at least in part on the one or more formats for indicating selected reference signals.

Some aspects described herein relate to a non-transitory computer-readable medium that stores a set of instructions for wireless communication by a UE. The set of instructions, when executed by one or more processors of the UE, may cause the UE to receive, from a network node, configuration information indicating that the UE is to measure N reference signals and report K reference signals, wherein N and K are integers. The set of instructions, when executed by one or more processors of the UE, may cause the UE to transmit, to the network node, a measurement report indicating a combination index associated with K selected reference signals of the N reference signals and measurement values for the K selected reference signals.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating that the UE is to measure N reference signals and report K reference signals, wherein N and K are integers. The set of instructions, when executed by one or more processors of the network node, may cause the network node to receive, from the UE, a measurement report indicating a combination index associated with K selected reference signals of the N reference signals and measurement values for the K selected reference signals.

Some aspects described herein relate to a non-transitory computer-readable medium that stores a set of instructions for wireless communication by a UE. The set of instructions, when executed by one or more processors of the UE, may cause the UE to receive, from a network node, configuration information indicating that the UE is to measure N reference signals and report K reference signals, wherein N and K are integers. The set of instructions, when executed by one or more processors of the UE, may cause the UE to transmit, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating that the UE is to measure N reference signals and report K reference signals, wherein N and K are integers. The set of instructions, when executed by one or more processors of the network node, may cause the network node to receive, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to a non-transitory computer-readable medium that stores a set of instructions for wireless communication by a UE. The set of instructions, when executed by one or more processors of the UE, may cause the UE to receive, from a network node, configuration information indicating a combination index that corresponds to N selected reference signals, from a set of M reference signals, to be measured by the UE, wherein N and M are integers. The set of instructions, when executed by one or more processors of the UE, may cause the UE to transmit, to the network node, a measurement report associated with measurements of the N selected reference signals.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating a combination index that corresponds to N selected reference signals, from a set of M reference signals, to be measured by the UE, wherein N and M are integers. The set of instructions, when executed by one or more processors of the network node, may cause the network node to receive, from the UE, a measurement report associated with measurements of the N selected reference signals.

Some aspects described herein relate to a non-transitory computer-readable medium that stores a set of instructions for wireless communication by a UE. The set of instructions, when executed by one or more processors of the UE, may cause the UE to receive, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The set of instructions, when executed by one or more processors of the UE, may cause the UE to transmit, to the network node, a measurement report associated with measurements of the N selected reference signals.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The set of instructions, when executed by one or more processors of the network node, may cause the network node to receive, from the UE, a measurement report associated with measurements of the N selected reference signals.

Some aspects described herein relate to a non-transitory computer-readable medium that stores a set of instructions for wireless communication by a UE. The set of instructions, when executed by one or more processors of the UE, may cause the UE to receive, from a network node, configuration information indicating one or more formats for indicating selected reference signals. The set of instructions, when executed by one or more processors of the UE, may cause the UE to communicate with the network node based at least in part on the one or more formats for indicating selected reference signals.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating one or more formats for indicating selected reference signals. The set of instructions, when executed by one or more processors of the network node, may cause the network node to communicate with the UE based at least in part on the one or more formats for indicating selected reference signals.

Some aspects described herein relate to an apparatus for wireless communication. The apparatus may include means for receiving, from a network node, configuration information indicating that the apparatus is to measure N reference signals and report K reference signals, wherein N and K are integers. The apparatus may include means for transmitting, to the network node, a measurement report indicating a combination index associated with K selected reference signals of the N reference signals and measurement values for the K selected reference signals.

Some aspects described herein relate to an apparatus for wireless communication. The apparatus may include means for transmitting, to a UE, configuration information indicating that the UE is to measure N reference signals and report K reference signals, wherein N and K are integers. The apparatus may include means for receiving, from the UE, a measurement report indicating a combination index associated with K selected reference signals of the N reference signals and measurement values for the K selected reference signals.

Some aspects described herein relate to an apparatus for wireless communication. The apparatus may include means for receiving, from a network node, configuration information indicating that the apparatus is to measure N reference signals and report K reference signals, wherein N and K are integers. The apparatus may include means for transmitting, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to an apparatus for wireless communication. The apparatus may include means for transmitting, to a UE, configuration information indicating that the UE is to measure N reference signals and report K reference signals, wherein N and K are integers. The apparatus may include means for receiving, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Some aspects described herein relate to an apparatus for wireless communication. The apparatus may include means for receiving, from a network node, configuration information indicating a combination index that corresponds to N selected reference signals, from a set of M reference signals, to be measured by the apparatus, wherein N and M are integers. The apparatus may include means for transmitting, to the network node, a measurement report associated with measurements of the N selected reference signals.

Some aspects described herein relate to an apparatus for wireless communication. The apparatus may include means for transmitting, to a UE, configuration information indicating a combination index that corresponds to N selected reference signals, from a set of M reference signals, to be measured by the UE, wherein N and M are integers. The apparatus may include means for receiving, from the UE, a measurement report associated with measurements of the N selected reference signals.

Some aspects described herein relate to an apparatus for wireless communication. The apparatus may include means for receiving, from a network node, configuration information indicating respective reference signal index values for N selected reference signals, from a set of M reference signals, to be measured by the apparatus, wherein N and M are integers, and wherein a respective reference signal index value for an i-th selected reference signal of the N selected reference signals is determined from a set of M−i+1 remaining reference signals of the M reference signals. The apparatus may include means for transmitting, to the network node, a measurement report associated with measurements of the N selected reference signals.

Some aspects described herein relate to an apparatus for wireless communication. The apparatus may include means for transmitting, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The apparatus may include means for receiving, from the UE, a measurement report associated with measurements of the N selected reference signals.

Some aspects described herein relate to an apparatus for wireless communication. The apparatus may include means for receiving, from a network node, configuration information indicating one or more formats for indicating selected reference signals. The apparatus may include means for communicating with the network node based at least in part on the one or more formats for indicating selected reference signals.

Some aspects described herein relate to an apparatus for wireless communication. The apparatus may include means for transmitting, to a UE, configuration information indicating one or more formats for indicating selected reference signals. The apparatus may include means for communicating with the UE based at least in part on the one or more formats for indicating selected reference signals.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example of artificial intelligence and/or machine learning based beam management, in accordance with the present disclosure.

FIG. 6 is a diagram illustrating an example associated with a format for indicating selected reference signals, in accordance with the present disclosure.

FIG. 7 is a diagram illustrating an example associated with a format for indicating selected reference signals, in accordance with the present disclosure.

FIG. 8 is a diagram illustrating an example associated with formats for indicating selected reference signals, in accordance with the present disclosure.

FIGS. 9A-9B are diagrams illustrating an example associated with formats for indicating selected reference signals, in accordance with the present disclosure.

FIGS. 10A-10C are diagrams illustrating an example associated with formats for indicating selected reference signals, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram illustrating an example process performed, for example, by a UE, in accordance with the present disclosure.

FIG. 14 is a diagram illustrating an example process performed, for example, by a network node, in accordance with the present disclosure.

FIG. 15 is a diagram illustrating an example process performed, for example, by a UE, in accordance with the present disclosure.

FIG. 16 is a diagram illustrating an example process performed, for example, by a network node, in accordance with the present disclosure.

FIG. 17 is a diagram illustrating an example process performed, for example, by a UE, in accordance with the present disclosure.

FIG. 18 is a diagram illustrating an example process performed, for example, by a network node, in accordance with the present disclosure.

FIG. 19 is a diagram illustrating an example process performed, for example, by a UE, in accordance with the present disclosure.

FIG. 20 is a diagram illustrating an example process performed, for example, by a network node, in accordance with the present disclosure.

FIG. 21 is a diagram of an example apparatus for wireless communication, in accordance with the present disclosure.

FIG. 22 is a diagram of an example apparatus for wireless communication, in accordance with the present disclosure.

### DETAILED DESCRIPTION

Beam indices are values that are used to identify beams, such as beams on which beam measurements are to be performed by a user equipment (UE) or beams for which beam measurements are being reported by a UE, among other examples. In some examples, beam indices may be indices associated with reference signals (e.g., reference signal indices). For example, an index associated with a reference signal may indicate a beam associated with the reference signal (e.g., a beam on which the reference signal is transmitted). In some examples, a wireless communication device may indicate a selection of beams (e.g., beams to be measured or beams for which measurements are reported, among other examples) by indicating a number of selected reference signals from a set of reference signals. In some examples, a bitmap format may be used to indicate selected reference signals from a set of reference signals. For example, the bitmap format may be used by a network node to indicate which reference signals, from a set of reference signals, are to be measured by a UE. In some examples, an index reporting format may be used to indicate selected reference signals from a set of reference signals. For example, the index reporting format may be used by a UE to indicate a number of top reference signals for which measurements are being reported among a set of reference signals measured by the UE.

In some examples, new or recently developed application scenarios may require a UE to measure an increasing number of beams and/or include measurements for an increasing number of beams in a report that is transmitted to a network node. That is, a total number of reference signals measured by the UE and/or a number of selected reference signals for which measurements are reported by the UE may increase, as compared to current beam management techniques. As a result, the signaling overhead associated with indicating the selected reference signals from the total number of reference signals may increase, which may result in increased consumption of network resources, increased traffic latency, and decreased traffic throughput.

Various aspects relate generally to formats for indicating beam indices. Some aspects more specifically relate to formats for indicating a first quantity of selected reference signals out of a second quantity of reference signals with reduced signaling overhead. In some aspects, a wireless communication device (e.g., a UE or a network node) may use a format associated with a combination index to indicate a first quantity of selected reference signals out of a set of a second quantity of reference signals. In such examples, the wireless communication device may transmit, to another wireless communication device, an indication of a combination index associated with a combination of the first quantity of selected reference signals out of the second quantity of reference signals. In some examples, a UE may use a combination index to indicate K reported reference signals out of N measured reference signals. For example, the UE may receive, from a network node, configuration information indicating that the UE is to measure N reference signals and report K reference signals, and the UE may transmit, to the network node, a measurement report indicating a combination index associated with K selected reference signals of the N reference signals and measurement values for the K selected reference signals. In some examples, a network node may use a combination index to indicate a subset of N selected reference signals to be measured by a UE out of a set of M reference signals. For example, the UE may receive, from the network node, configuration information indicating a combination index that corresponds to N selected reference signals, from a set of M reference signals, to be measured by the UE, and the UE may transmit, to the network node, a measurement report associated with measurements of the N selected reference signals.

In some aspects, a wireless communication device (e.g., a UE or a network node) may use a modified index reporting format to indicate a first quantity of selected reference signals out of a set of a second quantity of reference signals. In the modified index reporting format, in an example in which the first quantity is K and the second quantity is N, indices for the K selected reference signals may be sequentially determined in order from a first reference signal index to a Kth reference signal index, and each reference signal index may be determined with respect to a set of remaining reference signals, of the N reference signals, that does not include any previous reference signals of the K selected reference signals. For example, the wireless communication device may transmit, to another wireless communication device, an indication of respective reference signal index values for K selected reference signals of N reference signals, where a respective reference signal for an i-th selected reference signal of the K selected reference signals is determined from a set of N−i+1 remaining reference signals of the N selected reference signals. In some examples, a UE may use the modified index reporting format to indicate, to a network node, K reported reference signals out of N measured reference signals. In some examples, a network node may use the modified index reporting format to indicate, to a UE, a subset of N selected reference signals to be measured by the UE out of a set of M reference signals.

In some aspects, a UE may receive, from a network node configuration information that indicates one or more formats for indicating selected reference signals, and the UE and the network node may communicate based at least in part on the one or more formats for indicating selected reference signals. For example, the UE may transmit, to the network node, capability information indicating one or more supported formats for indicating selected reference signals, and the UE may be configured with one or more formats based at least in part on the capability information. In some examples, multiple formats for indicating selected reference signals may be configured for the UE, and the UE may select a format, of the multiple formats, to use in a measurement report to indicate K selected reference signals of N measured reference signals. For example, the UE may select the format, of the multiple formats, based at least in part on report payload sizes associated with the multiple formats. In some examples, multiple formats for indicating selected reference signals may be configured for the UE, and the network node may select a format, of the multiple formats, to be used to indicate N selected reference signals, of a set of M reference signals, to be measured by the UE. For example, the network node may select the format, of the multiple formats, based at least in part on payload sizes associated with the multiple formats.

Particular aspects of the subject matter described in this disclosure can be implemented to realize one or more of the following potential advantages. In some examples, by using a combination index to indicate a first quantity of selected reference signals from a set of a second quantity of reference signals, the described techniques can be used to reduce signaling overhead (e.g., as compared to the bitmap format and/or the index reporting format), resulting in reduced consumption of network resources, decreased traffic latency, and increased traffic throughput. In some examples, by using the modified index reporting format to indicate a first quantity of selected reference signals from a set of a second quantity of reference signals, the described techniques can be used to reduce signaling overhead (e.g., as compared to the bitmap format and/or the index reporting format), resulting in reduced consumption of network resources, decreased traffic latency, and increased traffic throughput. In some examples, by enabling configuring a UE to use one or more formats for indicating selected reference signals (e.g., based at least in part on a capability of the UE), the described techniques can be used to increase flexibility in selecting a format to be used by the UE. For example, a UE may select a format to be used for an indication of K selected reported reference signals from a set of N measured reference signals based at least in part on payload sizes associated with different formats for the values of K and N. Additionally, or alternatively, a network node may select a format to be used for an indication of N selected reference signals to be measured by the UE from a set of M reference signals. As a result, signaling overhead for indicating the selected reference signals may be reduced, resulting in reduced consumption of network resources, decreased traffic latency, and increased traffic throughput.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

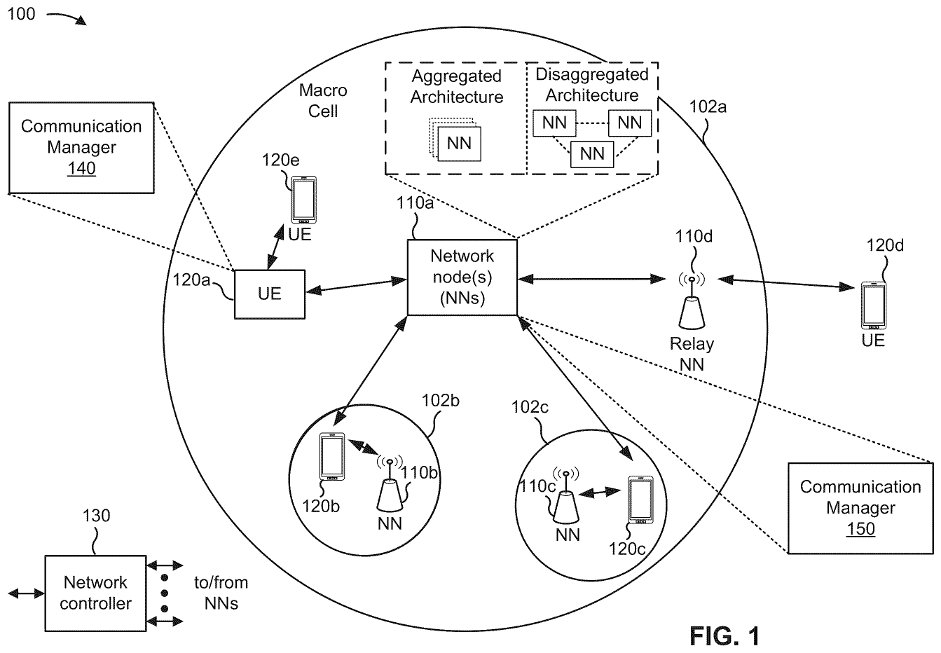

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating that the UE is to measure N reference signals and report K reference signals, wherein N and K are integers; and transmit, to the network node, a measurement report indicating a combination index associated with K selected reference signals of the N reference signals and measurement values for the K selected reference signals.

Additionally, or alternatively, as described in more detail elsewhere herein, the communication manager 140 may receive, from a network node, configuration information indicating that the UE is to measure N reference signals and report K reference signals, wherein N and K are integers; and transmit, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Additionally, or alternatively, as described in more detail elsewhere herein, the communication manager 140 may receive, from a network node, configuration information indicating a combination index that corresponds to N selected reference signals, from a set of M reference signals, to be measured by the UE, wherein N and M are integers; and transmit, to the network node, a measurement report associated with measurements of the N selected reference signals.

Additionally, or alternatively, as described in more detail elsewhere herein, the communication manager 140 may receive, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and transmit, to the network node, a measurement report associated with measurements of the N selected reference signals.

Additionally, or alternatively, as described in more detail elsewhere herein, the communication manager 140 may receive, from a network node, configuration information indicating one or more formats for indicating selected reference signals; and communicate with the network node based at least in part on the one or more formats for indicating selected reference signals. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information indicating that the UE is to measure N reference signals and report K reference signals, wherein N and K are integers; and receive, from the UE, a measurement report indicating a combination index associated with K selected reference signals of the N reference signals and measurement values for the K selected reference signals.

Additionally, or alternatively, as described in more detail elsewhere herein, the communication manager 150 may transmit, to a UE, configuration information indicating that the UE is to measure N reference signals and report K reference signals, wherein N and K are integers; and receive, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Additionally, or alternatively, as described in more detail elsewhere herein, the communication manager 150 may transmit, to a UE, configuration information indicating a combination index that corresponds to N selected reference signals, from a set of M reference signals, to be measured by the UE, wherein N and M are integers; and receive, from the UE, a measurement report associated with measurements of the N selected reference signals.

Additionally, or alternatively, as described in more detail elsewhere herein, the communication manager 150 may transmit, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and receive, from the UE, a measurement report associated with measurements of the N selected reference signals.

Additionally, or alternatively, as described in more detail elsewhere herein, the communication manager 150 may transmit, to a UE, configuration information indicating one or more formats for indicating selected reference signals; and communicate with the UE based at least in part on the one or more formats for indicating selected reference signals. Additionally, or alternatively, the communication manager 150 may perform one or more other operations described herein.

As indicated above, FIG. 1 is provided as an example. Other examples may differ from what is described with regard to FIG. 1.

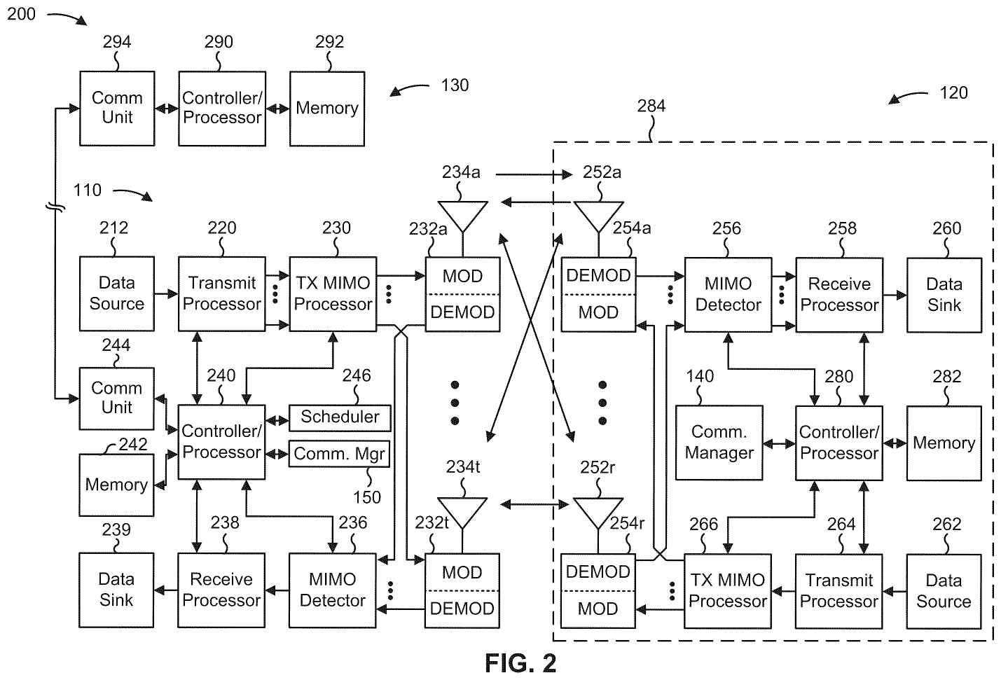

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

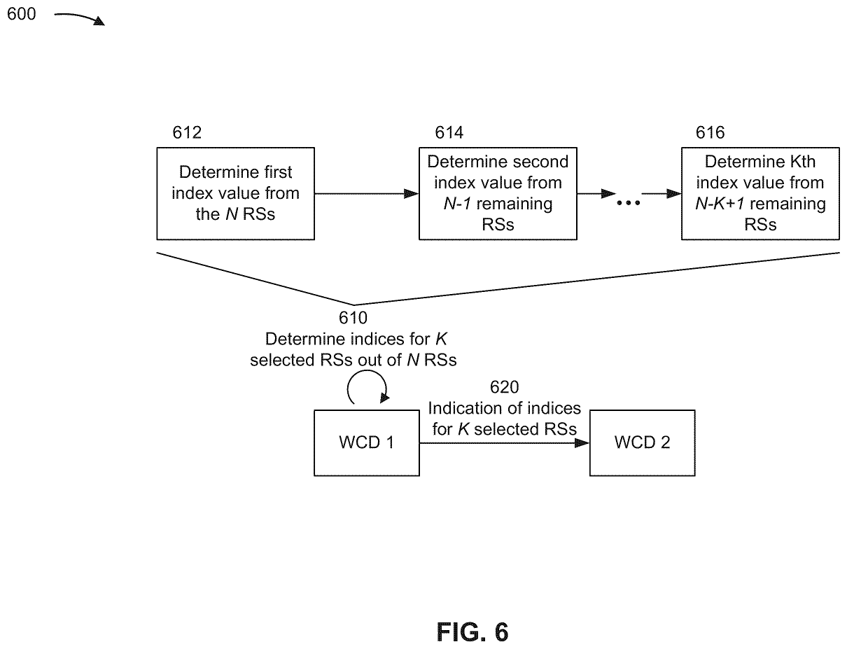

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-22).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-22).

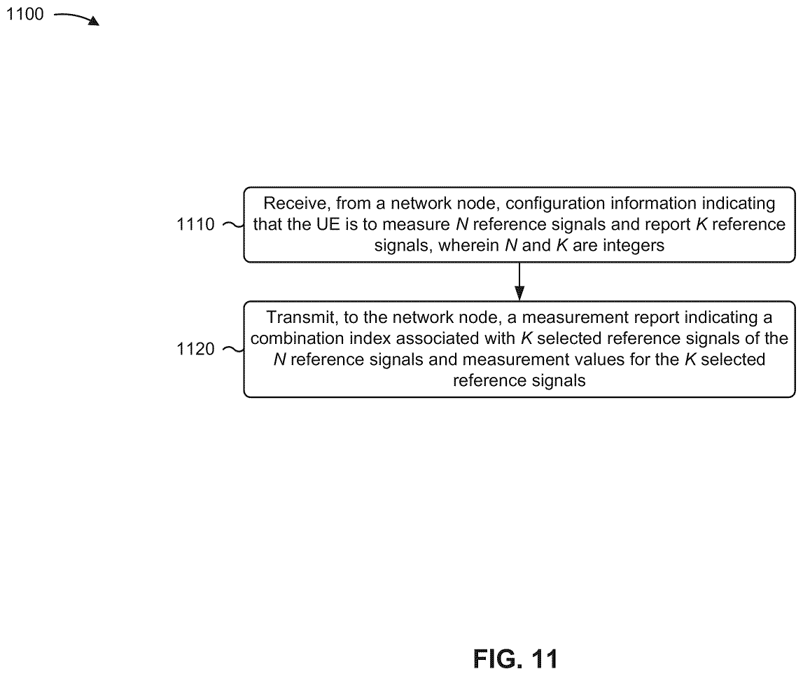

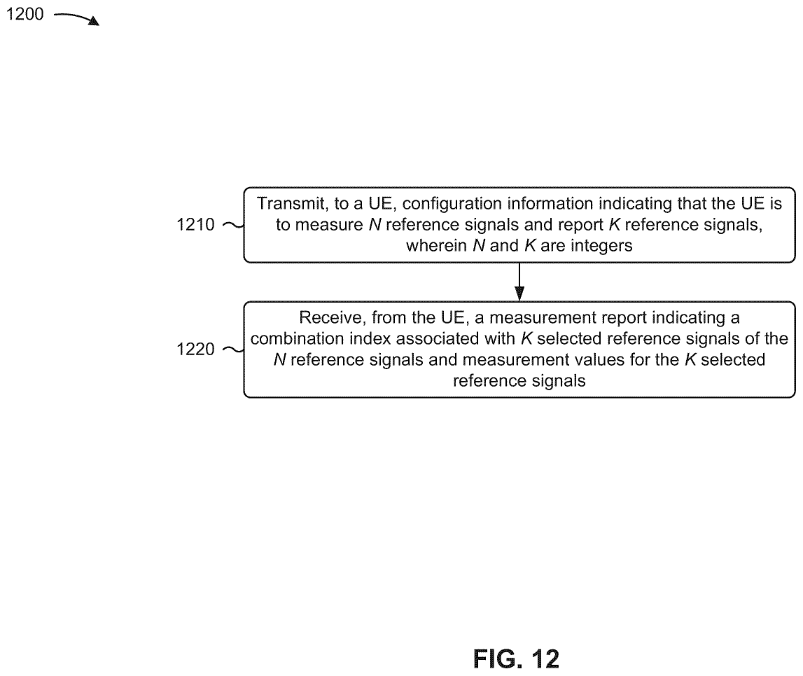

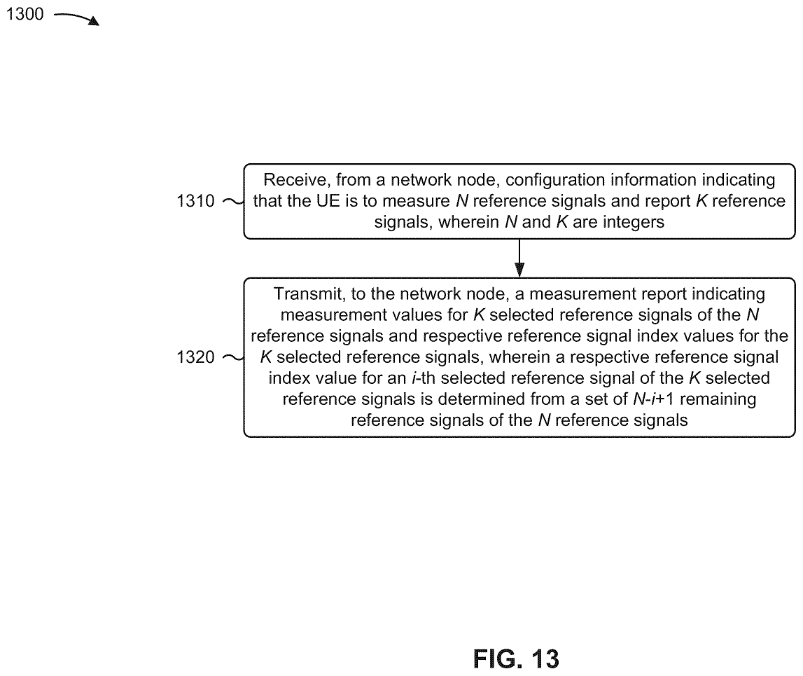

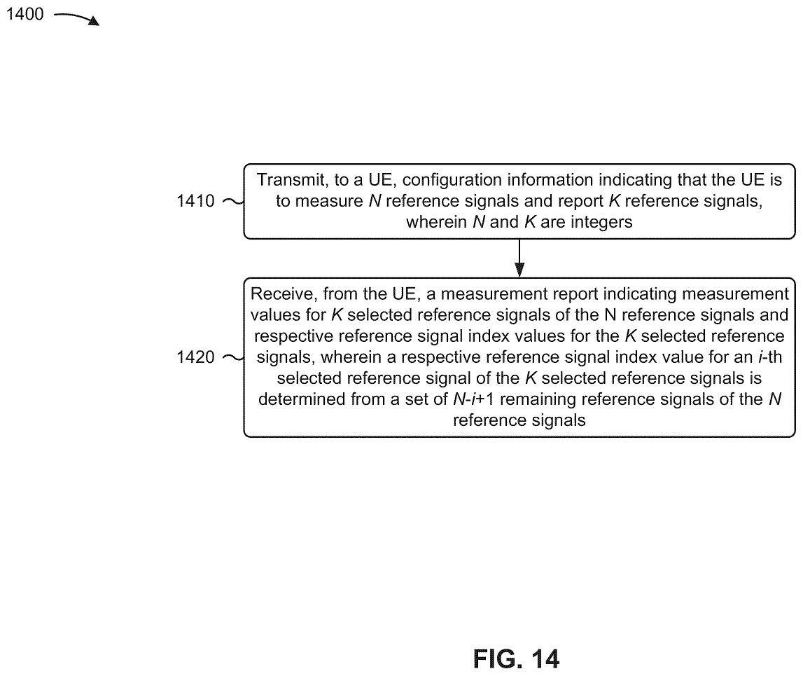

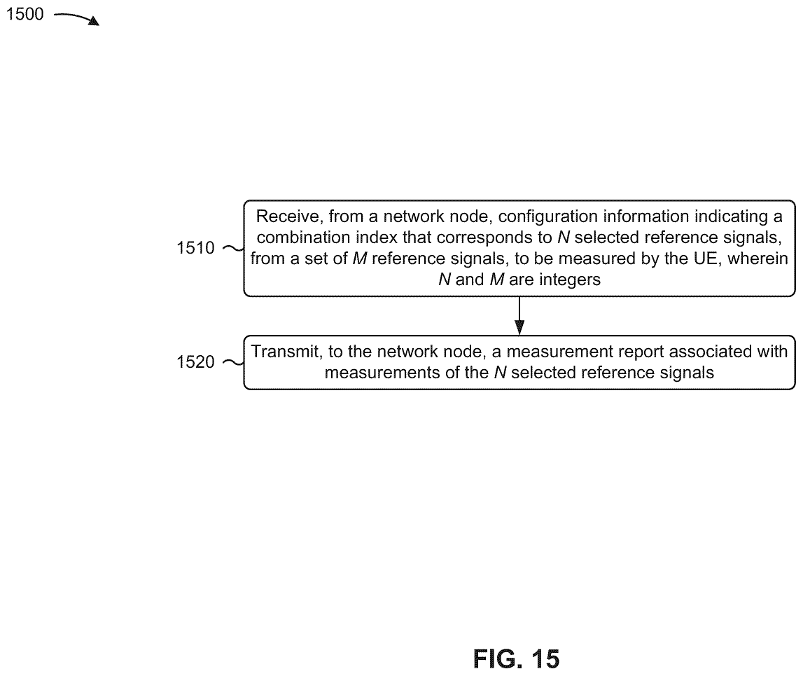

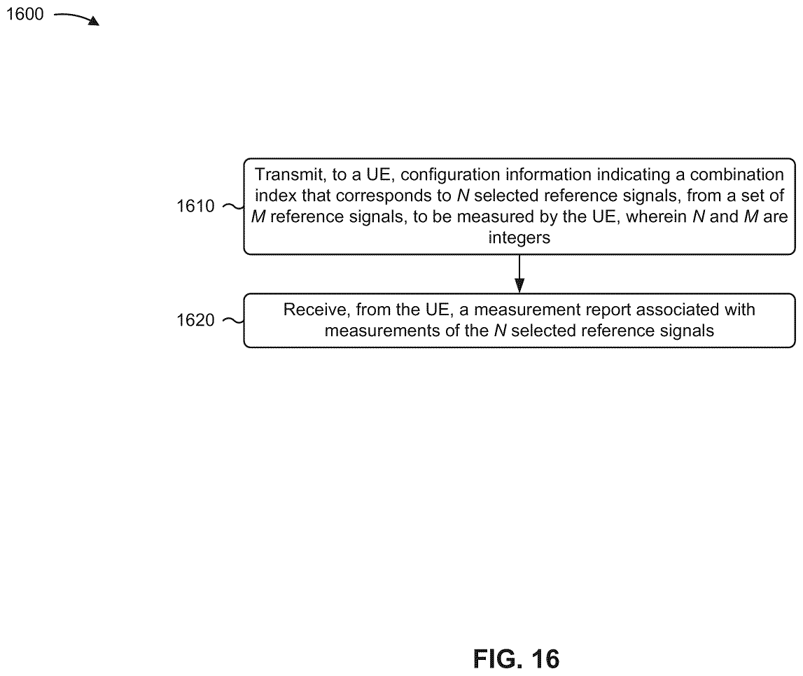

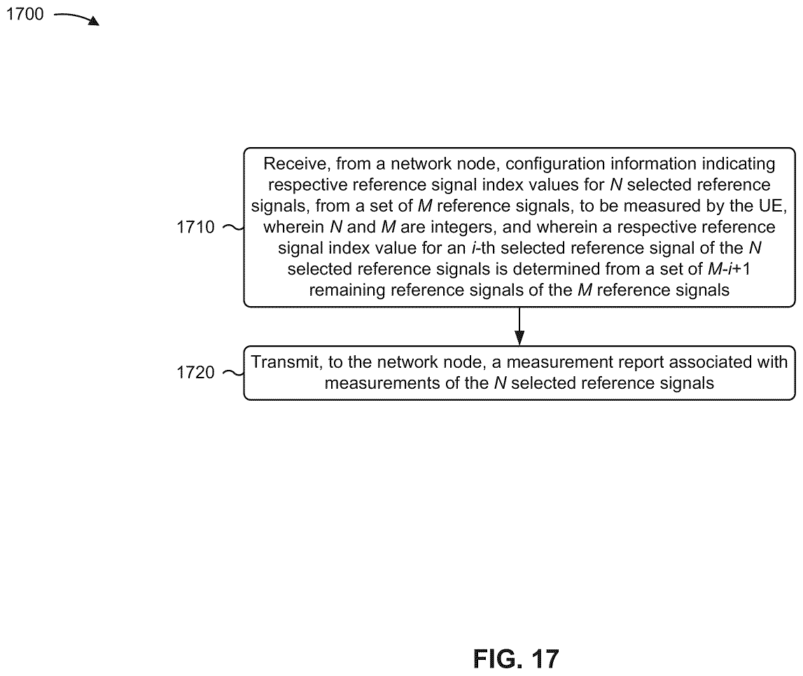

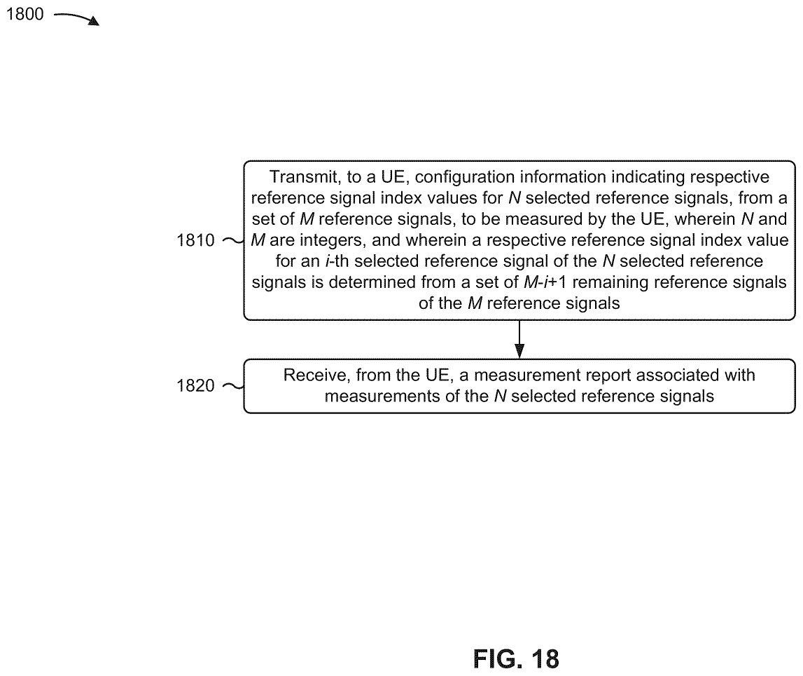

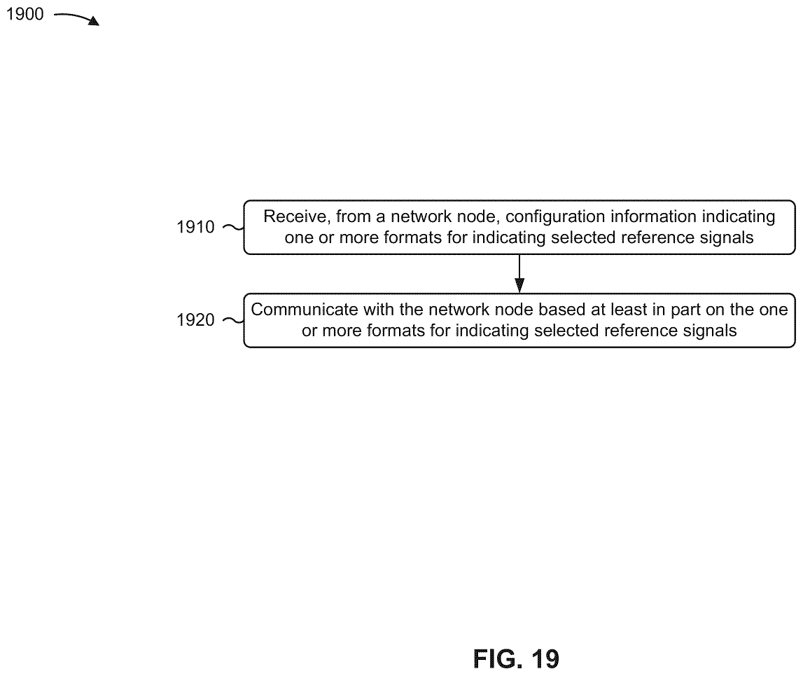

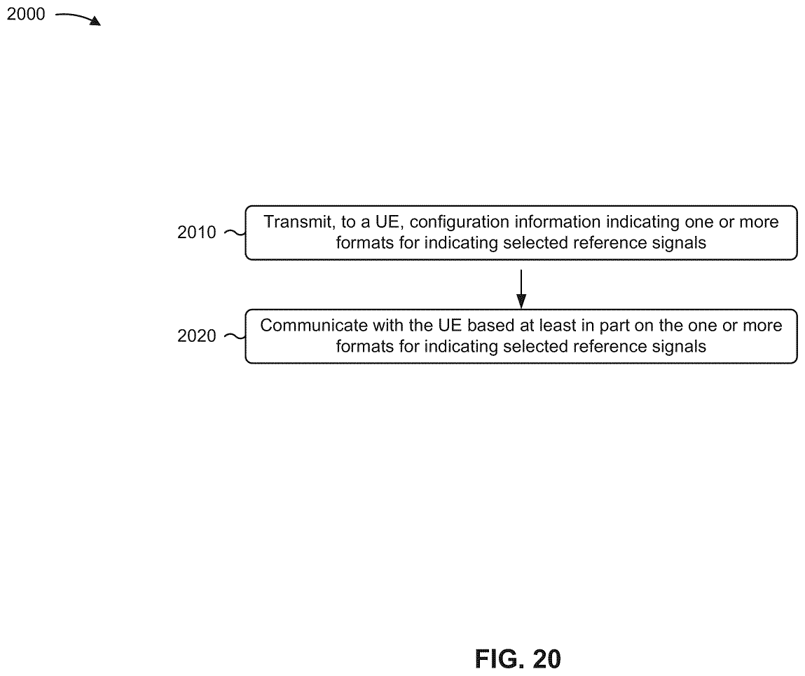

The controller/processor 240 of the network node 110, the controller/processor 280 of the UE 120, and/or any other component(s) of FIG. 2 may perform one or more techniques associated with formats for indicating beam indices, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, configuration information indicating that the UE is to measure N reference signals and report K reference signals, wherein N and K are integers; and/or means for transmitting, to the network node, a measurement report indicating a combination index associated with K selected reference signals of the N reference signals and measurement values for the K selected reference signals.

In some aspects, a UE (e.g., the UE 120) includes means for receiving, from a network node, configuration information indicating that the UE is to measure N reference signals and report K reference signals, wherein N and K are integers; and/or means for transmitting, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

In some aspects, a UE (e.g., the UE 120) includes means for receiving, from a network node, configuration information indicating a combination index that corresponds to N selected reference signals, from a set of M reference signals, to be measured by the UE, wherein N and M are integers; and/or means for transmitting, to the network node, a measurement report associated with measurements of the N selected reference signals.

In some aspects, a UE (e.g., the UE 120) includes means for receiving, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and/or means for transmitting, to the network node, a measurement report associated with measurements of the N selected reference signals.

In some aspects, a UE (e.g., the UE 120) includes means for receiving, from a network node, configuration information indicating one or more formats for indicating selected reference signals; and/or means for communicating with the network node based at least in part on the one or more formats for indicating selected reference signals. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, configuration information indicating that the UE is to measure N reference signals and report K reference signals, wherein N and K are integers; and/or means for receiving, from the UE, a measurement report indicating a combination index associated with K selected reference signals of the N reference signals and measurement values for the K selected reference signals.

In some aspects, a network node (e.g., the network node 110) includes means for transmitting, to a UE, configuration information indicating that the UE is to measure N reference signals and report K reference signals, wherein N and K are integers; and/or means for receiving, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

In some aspects, a network node (e.g., the network node 110) includes means for transmitting, to a UE, configuration information indicating a combination index that corresponds to N selected reference signals, from a set of M reference signals, to be measured by the UE, wherein N and M are integers; and/or means for receiving, from the UE, a measurement report associated with measurements of the N selected reference signals.

In some aspects, a network node (e.g., the network node 110) includes means for transmitting, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and/or means for receiving, from the UE, a measurement report associated with measurements of the N selected reference signals.

In some aspects, a network node (e.g., the network node 110) includes means for transmitting, to a UE, configuration information indicating one or more formats for indicating selected reference signals; and/or means for communicating with the UE based at least in part on the one or more formats for indicating selected reference signals. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

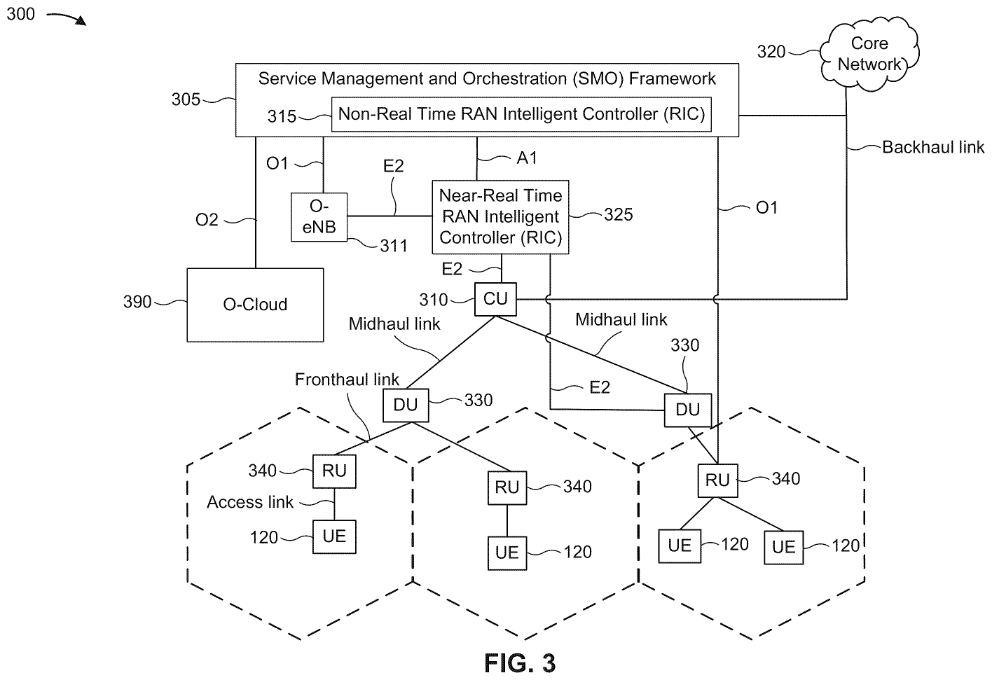

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

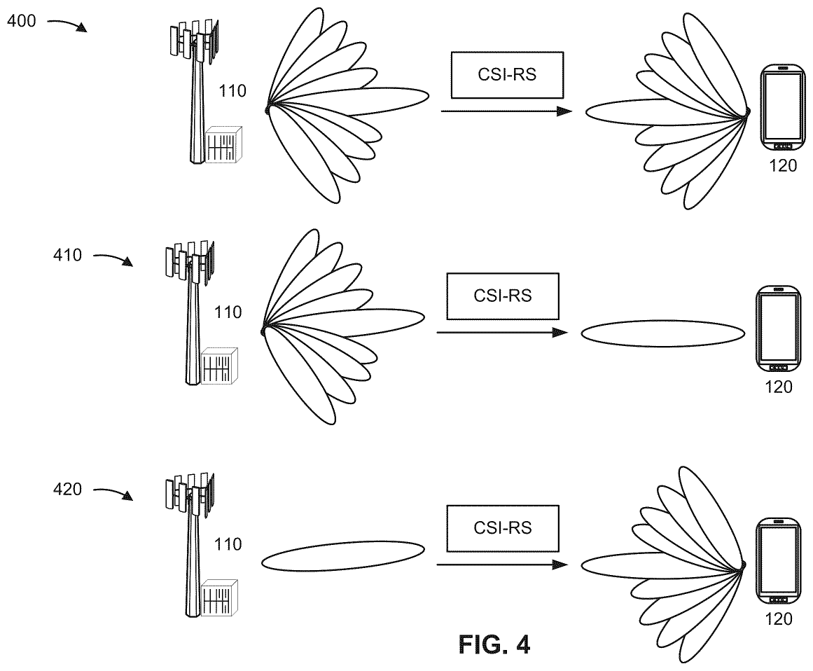

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using channel state information (CSI) reference signals (CSI-RSs). Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using MAC control element (MAC-CE) signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based on or otherwise in accordance with measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based on or otherwise in accordance with measurements performed in connection with the first beam management procedure). The second beam management procedure may enable the network node 110 to select a best transmit beam based on or otherwise in accordance with measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based on or otherwise in accordance with measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same reference signal (RS) resource set so that UE 120 can sweep through one or more receive beams in multiple transmission instances. The one or more receive beams may be a subset of all receive beams associated with the UE 120 (e.g., determined based on or otherwise in accordance with measurements performed in connection with the first beam management procedure and/or the second beam management procedure). The third beam management procedure may enable the network node 110 and/or the UE 120 to select a best receive beam based on or otherwise in accordance with reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

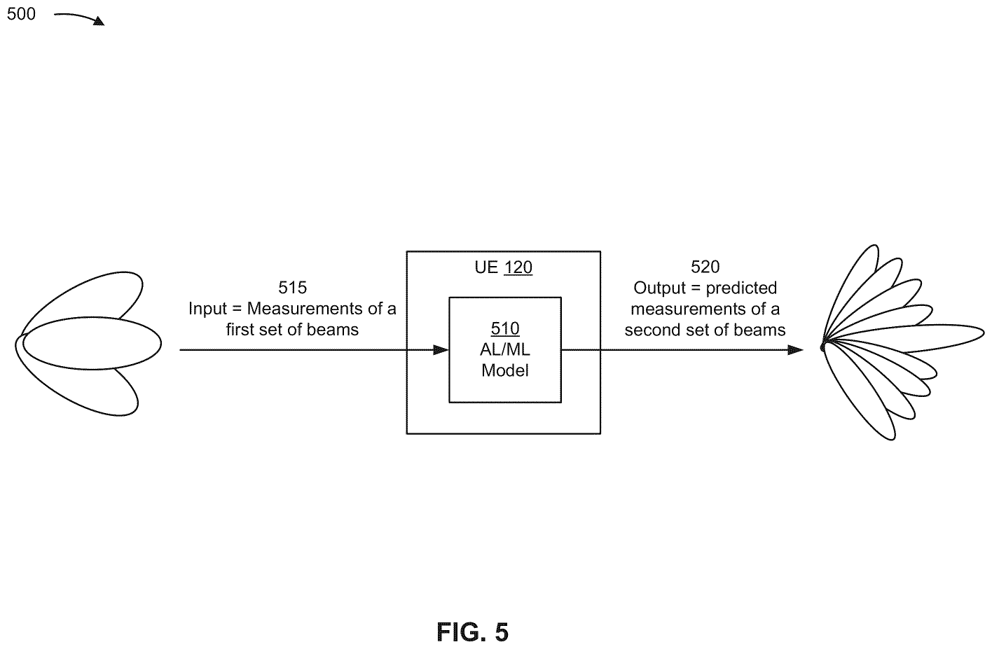

FIG. 5 is a diagram illustrating an example 500 of artificial intelligence and/or machine learning (AI/ML) based beam management, in accordance with the present disclosure. As shown in FIG. 5, an AI/ML model 510 may be deployed at or on a UE 120. For example, a model inference host may be deployed at, or on, a UE 120. The AI/ML model 510 may enable the UE 120 to determine one or more inferences or predictions based on data input to the AI/ML model 510.

For example, as shown by reference number 515, an input to the AI/ML model 510 may include measurements associated with a first set of beams. For example, a network node 110 may transmit one or more reference signals via respective beams from the first set of beams. The UE 120 may perform measurements (e.g., layer 1 (L1) RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 510 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 520, the AI/ML model 510 may output one or more predictions. The one or more predictions may include predicted measurement values (e.g., predicted L1 RSRP measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. The output(s) of the AI/ML model 510, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedures, beam failure and/or beam blockage predictions, and/or radio link failure predictions, among other examples.

In some examples, beam measurement predictions may be performed by a UE (e.g., as depicted in FIG. 5) and/or by a network node 110 in a similar manner as described above. For example, a network node 110 may receive one or more measurements (e.g., performed by a UE 120) and may use an AI/ML model 510 to predict one or more measurements (e.g., of other beams) based on or otherwise in accordance with the one or more measurements performed by the UE 120.

In some examples, the first set of beams (e.g., that are measured) may be referred to as “Set B beams” and the second set of beams (e.g., that are associated with predicted measurements) may be referred to as “Set A beams.” In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In some examples, the first set of beams (e.g., the Set A beams) may correspond to a subset of reference signals from a set of downlink reference signals (e.g., SSBs and/or CSI-RSs). In such examples, a network node 110 may configure the subset of reference signals to be measured by the UE.

In some examples, beams included in the first set of beams (e.g., the Set B beams) may be fixed over time and/or may follow a set or predictable pattern. For example, at various time domain measurement occasions, beams included in the first set of beams (e.g., the Set B beams to be measured by the UE 120 to facilitate a prediction of measurements of the Set A beams) may be fixed (e.g., the same) or may follow a set pattern. For example, the Set A beams may include 16 beams and the Set B beams may be a subset of the Set A beams. In some examples, at each time domain measurement occasion, the Set B beams may be the same subset of the Set A beams. In other examples, the set B beams may change at different time domain measurement occasions, but may follow a set or predictable pattern, such as a round-robin pattern.

As indicated above, FIG. 5 is provided as an example. Other examples may differ from what is described with regard to FIG. 5.

In some examples, a wireless communication device (e.g., a UE or a network node) may indicate a selection of beam indices by indicating a first quantity of selected reference signals from a set of a second quantity of reference signals. In some examples, a network node may indicate, to a UE, N reference signals to be measured by the UE out of a set of M total reference signals, where N and M are integers and N≤M. For example, a network node may indicate, to a UE, an SSB transmission pattern that includes a selected subset of SSBs (e.g., N SSBs) to be transmitted among all SSBs (e.g., M SSBs). In some other examples, a UE may measure N reference signals (e.g., CSI-RSs and/or SSBs) and the UE may report the K selected reference signals with the highest RSRP measurements in an L1 RSRP report, where K and N are integers and K≤N.

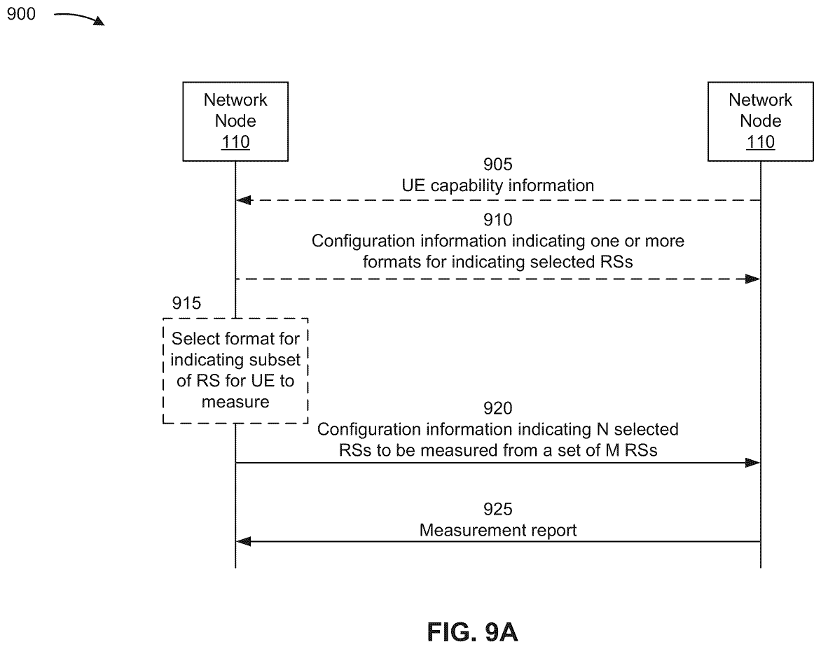

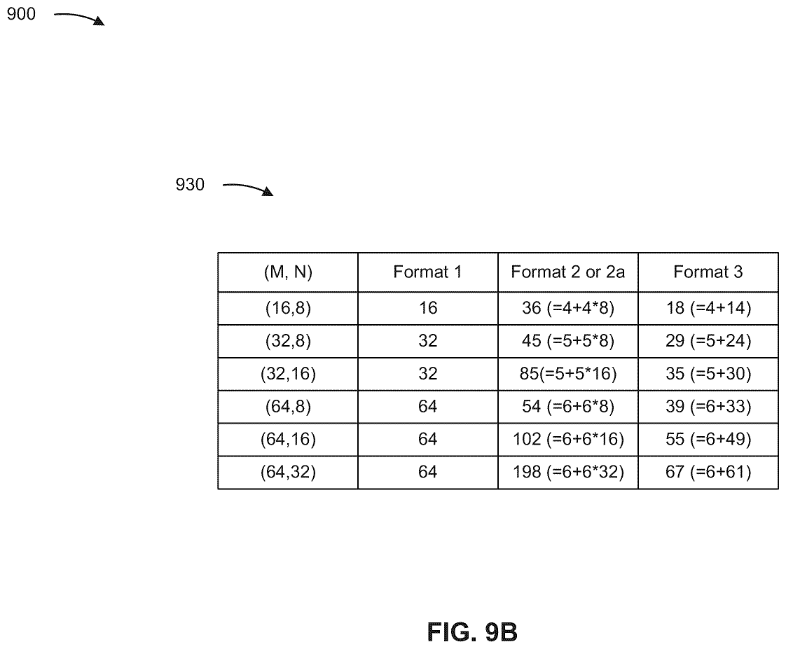

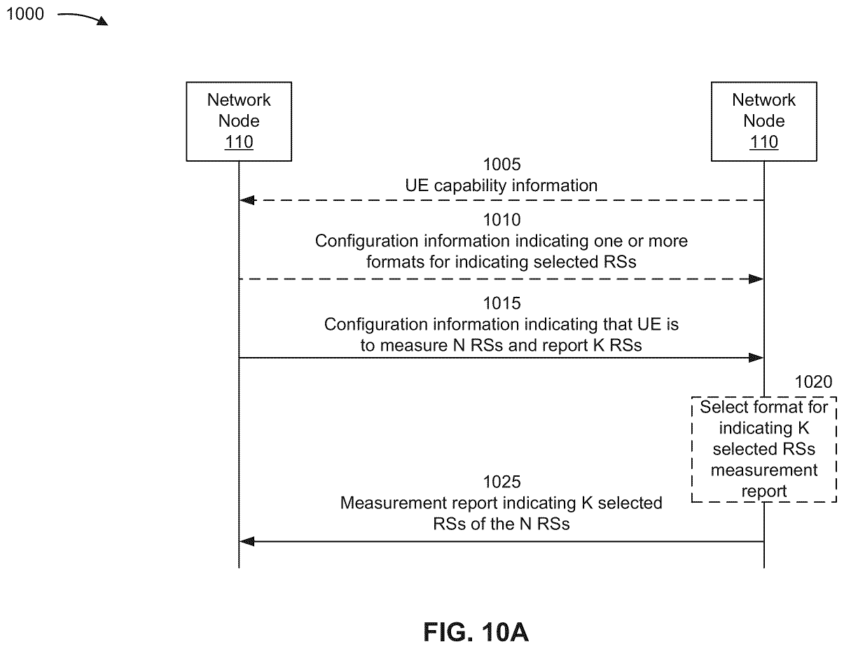

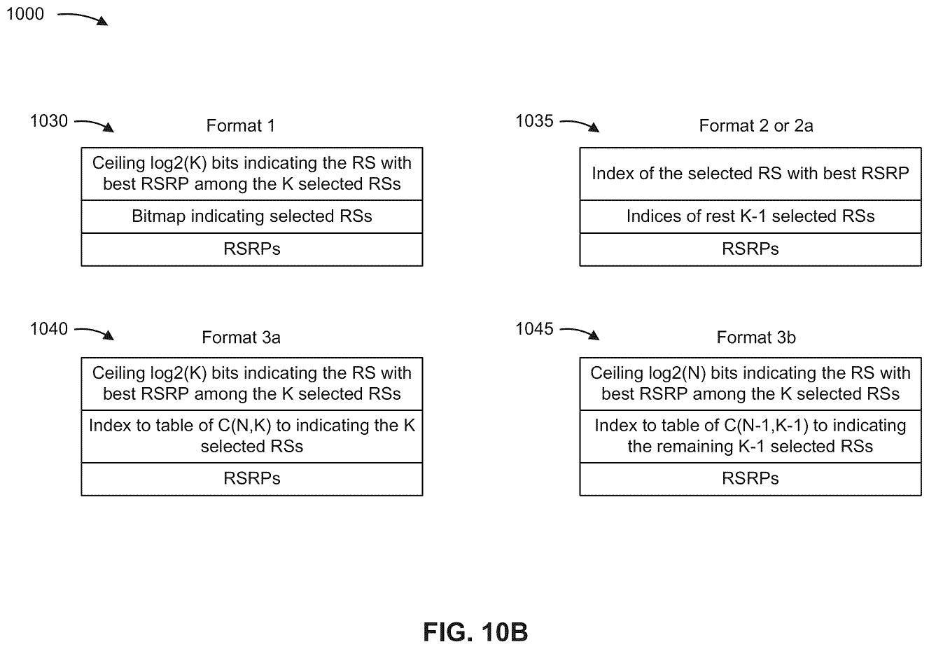

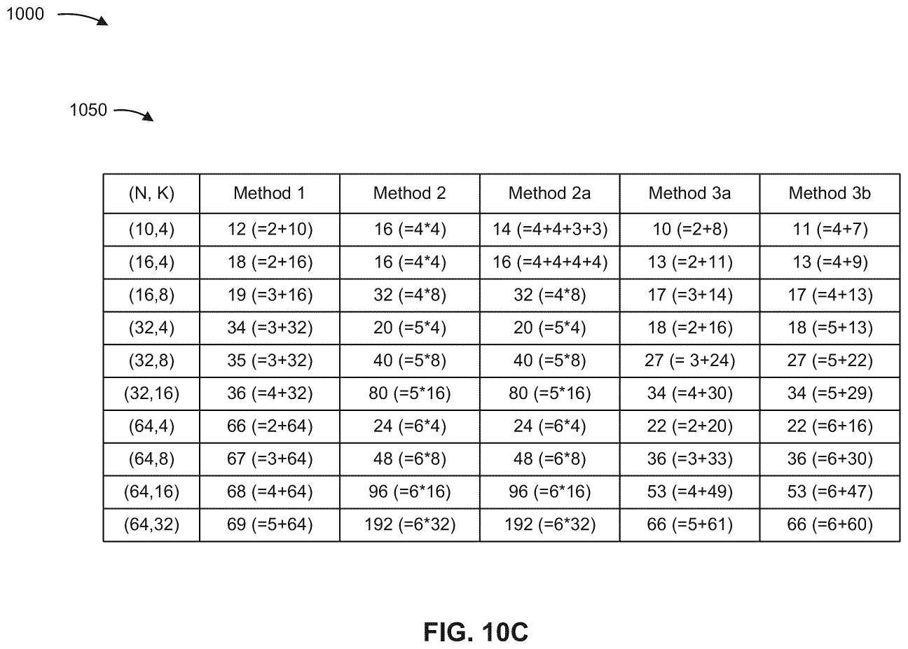

In some examples, a bitmap format may be used to indicate selected reference signals from a set of reference signals. The bitmap format may also be referred to herein as “Format 1.” Format 1 is described using “K” to represent a first quantity and “N” to represent a second quantity. It is to be understood that Format 1 may be used to indicate any first quantity of selected reference signals from any second quantity of reference signals. For example, Format 1 may be used to indicate N selected reference signals to be measured from a set of M total reference signals (e.g., as discussed in connection with FIGS. 9A-9B) or to indicate K selected reported reference signals from a set of N measured reference signals (e.g., as discussed in connection with FIGS. 10A-10C). Format 1 (e.g., the bitmap format) uses a bitmap to indicate K selected reference signals out of N reference signals. The bitmap may include N bits and each bit of the bitmap may correspond to a respective reference signal of the N reference signals. A bit of the bitmap may be assigned a first value (e.g., 1) to indicate that the corresponding reference signal is selected or a second value (e.g., 0) to indicate that the corresponding reference signal is not selected. Accordingly, the bitmap may include K bits having the first value (e.g., 1) that indicate the K selected reference signals of the N reference signal. For example, suppose that N=10 and K=4, and the four selected reference signal indices (e.g., the indices of the four selected reference signals) are 6, 3, 9, and 7 (e.g., the reference signal indices for the N reference signals start from 0 and go to N−1). In this example, the bitmap indicating the selected reference signals is 0001001101 (e.g., the left-most bit corresponds to reference signal index 0). In this example, the bitmap format (Format 1) uses 10 bits to indicate the selection. In some examples, the bitmap format (Format 1) may be used by a network node to indicate which reference signals, from a set of reference signals, are to be measured by a UE. For example, an SSB bitmap may be used to indicate an SSB transmission pattern (e.g., which N SSBs are to be transmitted, among a set of M SSBs).

In some examples, an index reporting format may be used to indicate selected reference signals from a set of reference signals. The index reporting format may also be referred to herein as “Format 2.” Format 2 is described using “K” to represent a first quantity and “N” to represent a second quantity. It is to be understood that Format 2 may be used to indicate any first quantity of selected reference signals from any second quantity of reference signals. For example, Format 2 may be used to indicate N selected reference signals to be measured from a set of M total reference signals (e.g., as discussed in connection with FIGS. 9A-9B) or to indicate K selected reported reference signals from a set of N measured reference signals (e.g., as discussed in connection with FIGS. 10A-10C). Format 2 (e.g., the index reporting format) indicates K selected reference signals out of N reference signals using a respective reference signal index (e.g., a respective reference signal resource index) to indicate each of the K selected reference signals. For example, Format 2 may indicate K reference signal indices, each identifying a respective one of the K selected reference signals, and the number of bits used to indicate each reference signal may be based on the value of N. In Format 2, the number of bits used to indicate each reference signal index may be ceiling(log₂N) (where ceiling(log₂N) is a smallest integer value that is greater than or equal to log₂ N), and the total number of bits used to indicate the K selected reference signal indices may be K*ceiling(log₂N). For example, suppose that N=10 and K=4, and the four selected reference signal indices are 6, 3, 9, and 7. In this example, the first reference signal index is 0110, the second reference signal index is 0011, the third reference signal index is 1001, and the fourth reference signal index is 0111. In this example, the index reporting format (Format 2) uses 16 bits to indicate the selection. In some examples, the index reporting format (Format 2) may be used by a UE in a measurement report to indicate a number of top reference signals among a set of reference signals measured by the UE. For example, the UE may use SSB resource indicators (SSBRIs) and/or CSI-RS resource indicators (CRIs) to indicate the selected K reference signals (e.g., SSBs and/or CSI-RSs) in an L1 RSRP report.

In some examples, new or recently developed application scenarios may require a UE to measure an increasing number of beams and/or include measurements for an increasing number of beams in a measurement report. In such examples, the values of N and K may be larger (possibly much larger) than in current beam management techniques. For example, for beam predication using an AI/ML model (e.g., as discussed in connection with FIG. 5), a UE may be configured to report predicted RSRP values and corresponding beam identifiers (IDs) (e.g., reference signal indices) across multiple future time periods (e.g., slots). In another example, for L1/layer 2 (L2) triggered mobility (LTM), a UE may be configured to measure beams from L candidate LTM cells and report a quantity of beams from each of the L candidate cells. In such examples, the signaling overhead associated with indicating the selected reference signals from the total reference signals may be large, which may result in increased traffic latency and decreased traffic throughput.

Various aspects relate generally to formats for indicating beam indices. Some aspects more specifically relate to formats for indicating a first quantity of selected reference signals out of a second quantity of reference signals with reduced signaling overhead. In some aspects, a wireless communication device (e.g., a UE or a network node) may use a modified index reporting format to indicate a first quantity of selected reference signals out of a set of a second quantity of reference signals. In the modified index reporting format, in an example in which the first quantity is K and the second quantity is N, indices for the K selected reference signals may be sequentially determined in order from a first reference signal index to a Kth reference signal index, and each reference signal index may be determined with respect to a set of remaining reference signals, of the N reference signals, that does not include any previous reference signals of the K selected reference signals. For example, the wireless communication device may transmit, to another wireless communication device, an indication of respective reference signal index values for K selected reference signals of N reference signals, where a respective reference signal for an i-th selected reference signal of the K selected reference signals is determined from a set of N−i+1 remaining reference signals of the N selected reference signals. In some examples, a UE may use the modified index reporting format to indicate, to a network node, K reported reference signals out of N measured reference signals. As a result, signaling overhead associated with indicating selected reference signals may be reduced, resulting in decreased traffic latency and increased traffic throughput.

In some aspects, a wireless communication device (e.g., a UE or a network node) may use a format associated with a combination index to indicate a first quantity of selected reference signals out of a set of a second quantity of reference signals. In such examples, the wireless communication device may transmit, to another wireless communication device, an indication of a combination index associated with a combination of the first quantity of selected reference signals of the second quantity of reference signals. As a result, signaling overhead associated with indicating selected reference signals may be reduced, resulting in decreased traffic latency and increased traffic throughput.

In some aspects, a UE may receive, from a network node, configuration information that indicates one or more formats for indicating selected reference signals, and the UE and the network node may communicate based at least in part on the one or more formats for indicating selected reference signals. For example, the UE may transmit, to the network node, capability information indicating one or more supported formats for indicating selected reference signals, and the UE may be configured with one or more formats based at least in part on the capability information. In some examples, multiple formats for indicating selected reference signals may be configured for the UE, and the UE may select a format, of the multiple formats, to use in a measurement report to indicate K selected reference signals of N measured reference signals. For example, the UE may select the format, of the multiple formats, based at least in part on report payload sizes associated with the multiple formats. In some examples, multiple formats for indicating selected reference signals may be configured for the UE, and the network node may select a format, of the multiple formats, to be used to indicate N selected reference signals, of a set of M reference signals, to be measured by the UE. For example, the network node may select the format, of the multiple formats, based at least in part on payload sizes associated with the multiple formats. As a result, flexibility may be increased and signaling overhead may be reduced for signaling associated with indicating selected reference signals, resulting in decreased traffic latency and increased traffic throughput.

FIG. 6 is a diagram illustrating an example 600 associated with a format for indicating selected reference signals, in accordance with the present disclosure. As shown in FIG. 6, example 600 includes communication between a first wireless communication device (shown as WCD 1) and a second wireless communication device (shown as WCD 2). In some aspects, the first wireless communication device and the second wireless communication device may be included in a wireless network, such as wireless network 100. In some aspects, the first wireless communication device may be a UE (e.g., UE 120) or a network node (e.g., network node 110). In some aspects, the second wireless communication device may be a network node (e.g., network node 110) or a UE (e.g., UE 120).

As shown in FIG. 6, in some aspects, a modified index reporting format may be used to indicate selected reference signals from a set of reference signals. For example, the modified index reporting format may be used by a wireless device (e.g., the first wireless device) to indicate K selected reference signals out of a set of N reference signals. The modified index reporting format discussed in connection with FIG. 6 may be referred to herein as “Format 2a.” Format 2a is described using “K” to represent a first quantity and “N” to represent a second quantity. It is to be understood that Format 2a may be used to indicate any first quantity of selected reference signals from any second quantity of reference signals. For example, Format 2a may be used to indicate N selected reference signals to be measured from a set of M total reference signals (e.g., as discussed in connection with FIGS. 9A-9B) or to indicate K selected reported reference signals from a set of N measured reference signals (e.g., as discussed in connection with FIGS. 10A-10C). Format 2a (e.g., the modified index reporting format) may indicate K selected reference signals out of N reference signals by indicating a respective reference signal index for each of the K selected reference signals (e.g., similar to Format 2). However, in Format 2a, the index values for the K selected reference signals are determined sequentially (e.g., starting with a first reference signal index), and the set of reference signals that is used to determine the index values decreases with an index value that is determined. In some examples, this may enable one or more reference signal indices, of the K reference signal indices, to be encoded with a reduced quantity of bits, as compared with the first reference signal index.

As shown in FIG. 6, and by reference number 610, the first wireless communication device may determine indices (e.g., index values) for K selected reference signals out of N reference signals using the modified index reporting format (e.g., Format 2a). In the Format 2a, indices for the K selected reference signals may be sequentially determined in order from a first reference signal index to a Kth reference signal index, and each reference signal index may be determined with respect to a set of remaining reference signals, of the N reference signals, that does not include any previous reference signals of the K selected reference signals. As shown by reference number 612, the first wireless communication device may determine a first reference signal index value (e.g., for the first selected reference signal of the K selected reference signals) from the N reference signals. As shown by reference number 614, the first wireless communication device may determine a second reference signal index value (e.g., for the second reference signal of the K selected reference signals) from the N−1 remaining (e.g., not yet selected) reference signals of the N reference signals after the selection of the first selected reference signal. That is, the N−1 remaining reference signals from which the second reference signal index is determined are the N−1 reference signals other than the first selected reference signal for which the first reference signal index value has already been determined. For example, once the first wireless communication device determines the index value for the first selected reference signal, the wireless communication device excludes the first selected reference signal from the set of reference signals from which the index value for the second selected reference signal is determined.

The first wireless communication device may similarly determine a respective reference signal index value for each remaining selected reference signal of the K selected reference signals, with each respective reference signal index value determined from a set of remaining reference signals, of the N reference signals, other than the previous selected reference signals for which reference signal index values have already been determined. As shown by reference number 616, the first wireless communication device may determine a Kth reference signal index value from the remaining N−K+1 reference signals of the N reference signals. The remaining N−K+1 reference signals are N−K+1 (e.g., N−(K−1)) reference signals remaining (e.g., not yet selected) from the N reference signals after the selection of the K−1 previous selected reference signals (e.g., the N−K+1 reference signals, of the N reference signals, other than the K−1 reference signals for which index values have already been determined). Accordingly, in Format 2a (e.g., the modified index reporting format), the respective reference signal for an i-th selected reference signal, of the K selected reference signals, may be determined from a set of N−i+1 remaining reference signals of the N selected reference signals.

As an example of indicating K selected reference signals out of N reference signals using Format 2a, suppose that N=10 and K=4, and the reference signal indices for the four selected reference signals are 6, 3, 9, and 7 in the full set of 10 reference signals (the reference signal indices for the N reference signals start from 0 and go to N−1). In this example, the first reference signal index value determined for the first selected reference signal is 0110, which indicates an index of 6 from the full set of 10 reference signals (e.g., indicating that the first selected reference signal is the seventh reference signal from the full set of 10 reference signals). The reference signal indices for the 9 remaining reference signals (e.g., other than the first selected reference signal) are then 0, 1, 2, 3, 4, 5, 7, 8, and 9. The second reference signal index value determined for the second selected reference signal is 0011, which indicates an index of 3 from the 9 remaining reference signals (e.g., indicating that the second selected reference signal is the fourth reference signal from the remaining 9 reference signals). The reference signal indices for the 8 remaining reference signals (e.g., other than the first and second selected reference signals) are then 0, 1, 2, 4, 5, 7, 8, and 9. The third reference signal index value determined for the third selected reference signal is 111, which indicates an index of 8 from the 8 remaining reference signals (e.g., indicating that the third selected reference signal is the eighth reference signal from the remaining 8 reference signals). The reference signal indices for the 7 remaining reference signals (e.g., other than the first and second selected reference signals) are then 0, 1, 2, 4, 5, 7, and 8. The fourth reference signal index value determined for the fourth selected reference signal is 101, which indicates an index of 5 from the 7 remaining reference signals (e.g., indicating that the fourth selected reference signal is the sixth reference signal from the remaining 8 reference signals). In this example, Format 2a (e.g., the modified index reporting format) uses 14 bits to indicate this selection. Accordingly, in this example, Format 2a (e.g., the modified index reporting format) saves two bits, as compared with Format 2 (e.g., the index reporting format).

As shown by reference number 620, the first wireless communication device may transmit, and the second wireless communication device may receive, an indication of the indices (e.g., index values) for the K selected reference signals. For example, the first wireless communication device may transmit, to the second wireless communication device, an indication of respective reference signal index values for K selected reference signals of N reference signals, where a respective reference signal for an i-th selected reference signal of the K selected reference signals is determined from the set of N−i+1 remaining reference signals of the N selected reference signals. The second wireless communication device may receive the indication of a respective reference signal index values for the K selected reference signals, and the second wireless communication device may determine and/or identify the K selected reference signals based at least in part on the indicated reference signal index values for the K selected reference signals.

In some aspects, the first wireless communication device may be a UE and the second wireless communication device may be a network node, and the first wireless communication device (e.g., the UE) may use the modified index reporting format (e.g., Format 2a) to indicate, to the second wireless communication device (e.g., the network node), K reported reference signals out of N measured reference signals. In some aspects, the first wireless communication device may be a network node and the second wireless communication device may be a UE, and the first wireless communication device (e.g., the network node) may use the modified index reporting format to indicate, to the second wireless communication device (e.g., a UE), a subset of K selected reference signals to be measured by the UE out of a set of N reference signals.

As indicated above, FIG. 6 is provided as an example. Other examples may differ from what is described with respect to FIG. 6.

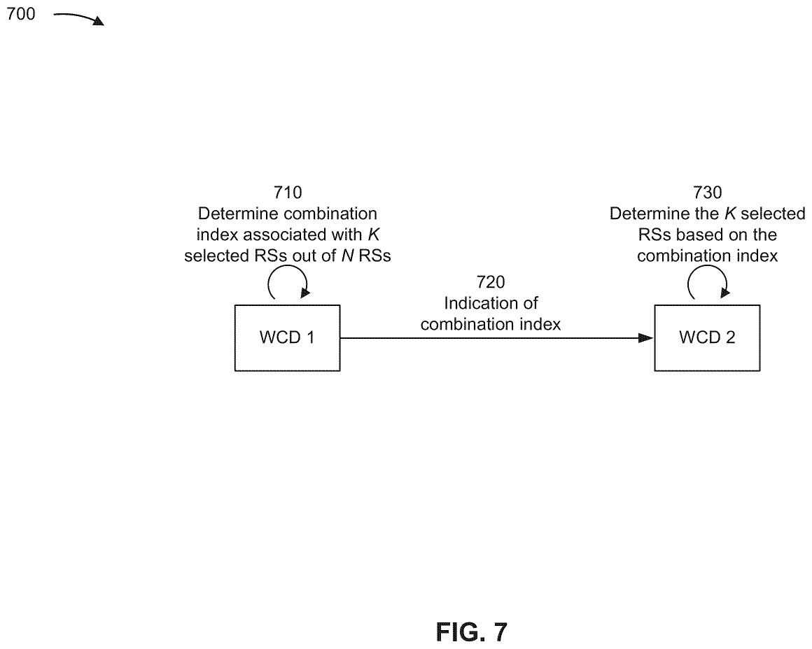

FIG. 7 is a diagram illustrating an example 700 associated with a format for indicating selected reference signals, in accordance with the present disclosure. As shown in FIG. 7, example 700 includes communication between a first wireless communication device (shown as WCD 1) and a second wireless communication device (shown as WCD 2). In some aspects, the first wireless communication device and the second wireless communication device may be included in a wireless network, such as wireless network 100. In some aspects, the first wireless communication device may be a UE (e.g., UE 120) or a network node (e.g., network node 110). In some aspects, the second wireless communication device may be a network node (e.g., network node 110) or a UE (e.g., UE 120).

As shown in FIG. 7, in some aspects, a combination index format may be used to indicate selected reference signals from a set of reference signals. For example, the combination index format may be used by a wireless device (e.g., the first wireless device) to indicate K selected reference signals out of a set of N reference signals. The combination index format discussed in connection with FIG. 7 may be referred to herein as “Format 3.” Format 3 is described using “K” to represent a first quantity and “N” to represent a second quantity. It is to be understood that Format 3 may be used to indicate any first quantity of selected reference signals from any second quantity of reference signals. For example, Format 3 may be used to indicate N selected reference signals to be measured from a set of M total reference signals (e.g., as discussed in connection with FIGS. 9A-9B) or to indicate K selected reported reference signals from a set of N measured reference signals (e.g., as discussed in connection with FIGS. 10A-10C). Format 3 (e.g., the combination index format) may indicate a combination index associated with a combination of K selected reference signals of N reference signals. As shown in FIG. 7, and by reference number 710, the first wireless communication device may determine a combination index that is associated with K selected reference signals out of N reference signals. As shown by reference number 720, the first wireless communication device may transmit, and the second wireless communication device may receive, an indication of the combination index. As shown by reference number 730, the second wireless communication device may determine the K reference signals based at least in part on the indicated combination index.

In some aspects, a table of possible combinations of K reference signals from a set of N reference signals may be defined, and the combination index can indicate (e.g., map to) a combination of K reference signals in the table of combinations. For example, different values of the combination index may map to different combinations of K reference signals in the table of combinations. In such examples, a wireless communication device (e.g., the first wireless communication device) may indicate/report the combination index (e.g., the index that maps to the selected combination of K reference signals) instead of indicating/reporting the individual reference signal indices. In some examples, the table of combinations may include all possible combinations of K reference signals from the set of N reference signals. There are C(N,K) different possible combinations of K reference signals from the set of N reference signals. The order of the K reference signals may be irrelevant for determining C(N,K). The number of bits used to indicate the combination index may be equal to ceiling(log₂C(N, K)). For example, in a case in which N=10 and K=4, there are 210 different combinations of 4 reference signals out of 10 reference signals (e.g., C(N,K)=210). In this example, Format 3 uses ceiling(log₂ 210)=8 bits to indicate a combination index that corresponds to a specific selection of 4 reference signals (for example, reference signal indices 6, 3, 9, and 7).

In some aspects, the first and second wireless communications devices (e.g., a UE and a network node) may share the same table of combinations, either by using a pre-defined table (e.g., a table of combinations defined in a wireless communication standard) for given N and K values, or by both generating the same table for given N and K values using the same rule (or set of rules). In some examples, a table of combinations of K reference signals out of N reference signals may be generated as follows. For each possible combination of K reference signals out of the N reference signals, a wireless communication device may first sort the selected K reference signal indices in ascending (or descending) order. The wireless communication device may then order all combinations lexicographically. For example, in a case in which N=6 and K=3, there are 20 possible selections of combinations of 3 reference signals. In this example, the 20 possible combinations may be ordered as: (0,1,2), (0,1,3), (0,1,4), (0,1,5), (0,2,3), (0,2,4), (0,2,5), (0,3,4), (0,3,5), (0,4,5), (1,2,3), (1,2,4), (1,2,5), (1,3,4), (1,3,5), (1,4,5), (2,3,4), (2,3,5), (2,4,5), (3,4,5). A respective combination index value may be assigned to each of the possible combinations based on the order of the combinations.

In some aspects, the first wireless communication device (e.g., a UE or a network node) may perform an algorithm to encode a specific combination of K reference signals out of N reference signals with a corresponding combination index without generating the table of combinations. In such examples, the second wireless communication device (e.g., a network node or a UE) may perform an algorithm to decode the specific combination of K reference signals out of N reference signals from the combination index indicated by first wireless communication device without generating the table of combinations. For each of the possible combinations of K reference signals from out of the N reference signals, the K choosing indices may be sorted in ascending (or descending) order, and then all of the combinations may be sorted lexicographically.

In some examples, the following algorithm may be used by the first wireless communication device to determine the combination index of a specific combination (a₁, a₂, . . . , a_{K}), in which a₁<a₂< . . . <a_{K}≤N−1, where the N reference signals are labeled 0, 1, . . . , N−1. A first value (x₁) equal to a number of combinations starting with 0, 1, . . . , a₁−1 may be determined as x₁=C(N−1, K−1)+C(N−2, K−1)+C(N−3, K−1)+ . . . +C(K−1, K−1) (e.g., define C(i, j)=0 if i<j). A second value (x₂) equal to a number of combinations with first position a₁, second position a₁+1, a₁+2, . . . , a₂−1 may be determined as x₂=C(N−a₁−1, K−2)+C(N−a₁−2, K−2), + . . . +C(K−2, K−2). A similar step may be performed for each position between the second position and the Kth position to determine a value (xᵢ) equal to a number of combinations with the first i−1 positions as (a₁, a₂, . . . , a₍ᵢ₋₁₎) and the ith position 0, 1, . . . , a₁−1. A number of combinations with the first K−1 positions as (a₁, a₂, . . . , a_{(K-1)}) and the Kth position 0, 1, . . . , a_{K}−1 may be determined as max(0, a_{K}). The combination index for the specific combination (a₁, a₂, . . . , a_{K}) may then be determined as x₁+x₂+ . . . +max(0, a_{K})−1.

In some examples, the following algorithm may be used by the second wireless communication device for decoding the specific combination of K reference signals from the indication of the combination index received from the first wireless communication device. A value for a₁ may be found (e.g., determined), such that the number of combinations with first position 0, 1, . . . a₁−1<the combination index≤the number of combinations with first position 0, 1, . . . , a₁. A value for a₂ may be found (e.g., determined) such that the number of combinations with first position a₁, second position a₁+1, a₁+2, . . . , a₂−1<the combination index≤the number of combinations with first position a₁, second position a₁+1, a₁+2, . . . , a₂. A similar step may be performed to find a value for aᵢ at each position until all of a₁, a₂, . . . , a_{K} are identified.

In some aspects, the first wireless communication device may be a UE and the second wireless communication device may be a network node, and the first wireless communication device (e.g., the UE) may use the combination index (e.g., Format 3) to indicate, to the second wireless communication device (e.g., the network node), K reported reference signals out of N measured reference signals. In some aspects, the first wireless communication device may be a network node and the second wireless communication device may be a UE, and the first wireless communication device (e.g., the network node) may use the combination index (e.g., Format 3) to indicate, to the second wireless communication device (e.g., the UE), a subset of K selected reference signals to be measured by the UE out of a set of N reference signals.

As indicated above, FIG. 7 is provided as an example. Other examples may differ from what is described with respect to FIG. 7.

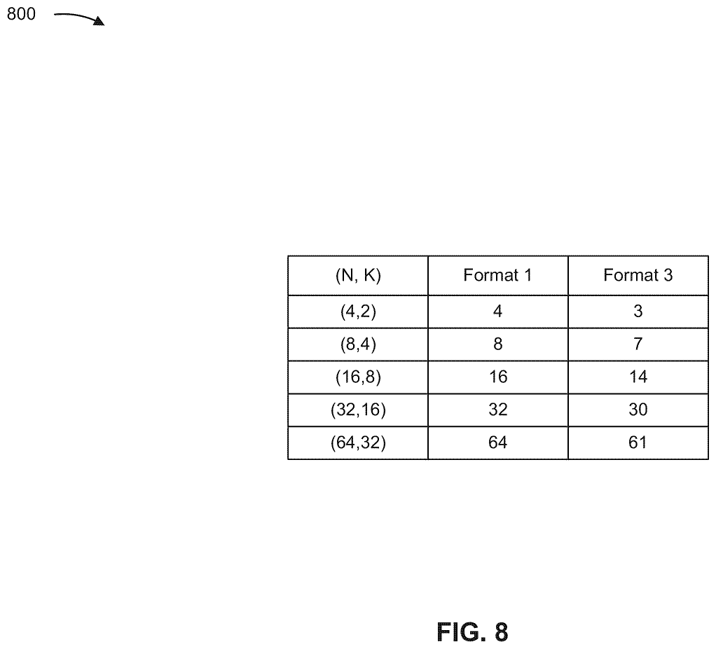

FIG. 8 is a diagram illustrating an example 800 associated with formats for indicating selected reference signals, in accordance with the present disclosure. To indicate K selected reference signals out of N reference signals, Format 1 (e.g., the bitmap format) uses N bits, Format 2 (e.g., the index reporting format) uses K*ceiling(log₂N) bits, Format 2a (e.g., the modified index reporting format) uses ceiling(log₂N)+ceiling(log₂(N−1))+ . . . +ceiling(log₂(N−K+1) bits, and Format 3 (e.g., the combination index format) uses

$$ceiling ( {log}_{2} ( \frac{N * ( N - 1 ) * ( N - 2 ) * … * ( N - K + 1 )}{K * ( K - 1 ) * ( K - 2 ) * … * 1} )$$

bits. Accordingly, Format 3 uses fewer bits or an equal number of bits (e.g., when K=1 or K=N−1) as compared with Format 2a, and Format 2a uses fewer bits or an equal number of bits as compared with Format 2. In some examples, when K>N/2, Format 3 may be equivalent to the following modification of Format 2 or Format 2a: instead of using indices for the selected reference signals, Format 2 or Format 2a may use indices of the unselected reference signals to indicate the selection of K reference signals among N reference signals.

Comparing the number of bits (N) used in Format 1 with the number of bits (K*ceiling(log₂N)) used in Format 2, Format 1 uses fewer bits than Format 2 when

$$\frac{N}{K} < ceiling ( {log}_{2} N ) .$$

For example, Format 1 may be better (e.g., use fewer bits) than Format 2 in a case in which N=10 and K=4. In this case, Format 1 uses 10 bits and Format 2 uses 4*4=16 bits. In another example, Format 2 may be better (e.g., use fewer bits) than Format 1 in a case in which N=32 and K=4. In this case, Format 1 uses 32 bits and Format 2 uses 4*5=20 bits.

As shown in FIG. 8, example 800 shows a table comparing bits used by Format 1 and Format 3 for different N and K values. Solving the binomial equation (1+x)^{N}=Σ_{K=0}ⁿC(N, K)x^{K} with x=1 shows that 2^{N}=Σ_{K=0}^{N}C(N, K). Hence, 2^{N}>C(N, K) and Format 3 is always no worse than Format 1 (e.g., Format 3 uses fewer bits or an equal number of bits to indicate K selected reference signals from N reference signals as compared with Format 1). Note that C(N, K) is largest when K=N/2. The table in FIG. 8 shows a comparison of bits used by Format 1 and Format 3 in examples in which K=N/2 (e.g., resulting in a highest number of bits for Format 3 for each value of N). As shown in FIG. 8, Format 3 uses fewer bits than Format 1 in all of the examples shown in the table.

In some aspects, Format 3 (e.g., the combination index format) may be applied in any case in which a first quantity (e.g., K) of selected items out of a second quantity (e.g., N) of items is to be indicated. For example, Format 3 may be used in a transmission configuration indicator (TCI) activation/deactivation MAC-CE to indicate which TCI states are to be activated or deactivated. Currently, to indicate activation/deactivation of 8 (e.g., N=8) TCI states out of 64 (e.g., N=64) configured TCI states, a MAC-CE uses a bitmap, with each bit corresponding to a respective configured TCI state. Such a bitmap uses 64 bits. Using Format 3 to indicate 8 TCI states out of 64 configured TCI states uses 33 bits, resulting in decreased signaling overhead as compared to the bitmap.

As indicated above, FIG. 8 is provided as an example. Other examples may differ from what is described with respect to FIG. 8.

FIGS. 9A-9B are diagrams illustrating an example 900 associated with formats for indicating selected reference signals, in accordance with the present disclosure. As shown in FIG. 9A, example 900 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 9A, and by reference number 905, in some aspects, the UE 120 may transmit, and the network node 110 may receive UE capability information indicating a capability of the UE 120 associated with one or more formats for indicating selected reference signals. In some aspects, the UE capability information may indicate one or more supported formats for indicating selected reference signals (e.g., one or more formats for indicating selected reference signals that are supported by the UE 120). In some aspects, the capability information may indicate that the UE 120 supports Format 3 (e.g., the combination index format) discussed in connection with FIG. 7. In some aspects, the capability information may indicate that the UE 120 supports Format 2a (e.g., the modified index reporting format) discussed in connection with FIG. 6.

In some aspects, the one or more supported formats indicated by the capability information may include one or more of Format 1 (e.g., the bitmap format), Format 2 (e.g., the index reporting format), Format 2a (e.g., the modified index reporting format), Format 3 (e.g., the combination index format), a format associated with machine learning compression of indices associated with selected reference signals, and/or a format associated with Huffman coding of indices associated with selected reference signals, among other examples. For example, different formats may require different levels of computational power, and different formats may be supported by different UEs.

As further shown in FIG. 9A, and by reference number 910, in some aspects, the network node 110 may transmit, and the UE 120 may receive, configuration information indicating one or more formats for indicating selected reference signals that are configured for the UE 120. For example, the one or more formats indicated in the configuration information may be based at least in part on the one or more supported formats indicated in the capability information.

In some aspects, the configuration information may indicate a configured format (a single configured format) for indicating selected reference signals. For example, the configuration information may indicate a configured format that is to be used by the network node 110 for indicating, to the UE 120, a subset of selected reference signals to be measured out of a set of reference signals. In some examples, the configured format may be Format 3 (e.g., the combination index format). In some examples, the configured format may be Format 2a (e.g., the modified index reporting format). In some other examples, the configured format may be another format (e.g., Format 1, Format 2, the format associated with machine learning compression of reference signal indices, or the format associated with Huffman coding of reference signal indices, among other examples).

In some aspects, the configuration information may indicate multiple formats for indicating selected reference signals. In such examples, the UE 120 may be configured with multiple formats for indicating selected reference signals. For example, the configuration information may indicate multiple formats from the supported formats indicated in the UE capability information. In some examples, the configuration information may indicate one or more of Format 1 (e.g., the bitmap format), Format 2 (e.g., the index reporting format), Format 2a (e.g., the modified index reporting format), Format 3 (e.g., the combination index format), the format associated with machine learning compression of indices associated with selected reference signals, and/or the format associated with Huffman coding of indices associated with selected reference signals, among other examples.

As further shown in FIG. 9A, and by reference number 915, in some aspects, the network node 110 may select a format for indicating selected reference signals. For example, in a case in which the configuration information indicates multiple formats that are configured for the UE 120, the network node 110 may select the format from the multiple formats indicated in the configuration information. In some examples, the network node 110 may select the format to be used for indicating N selected reference signals to be measured by the UE 120 from a set of M total reference signals. For example, the network node 110 may select the format to use for each indication of N selected reference signals out of the M total reference signals based at least in part on the values of N and M and based at least in part on the formats configured for the UE 120.

In some aspects, the network node 110 may select the format to be used for indicating N selected reference signals to be measured by the UE 120 from the set of M reference signals based at least in part on payload sizes associated with the formats configured for the UE 120 using a rule or set of rules (e.g., a preconfigured rule or set of rules). For example, the network node 110 may determine a payload size (e.g., a quantity of bits to be used) associated with each of the formats configured for the UE 120 based at least in part on the values of N and M, and the network node 110 may select a format with a smallest payload size. If multiple formats have the same smallest payload size, then the network node 110 may select from the multiple formats having the same payload size based at least in part on a rule (e.g., a preconfigured rule) that establishes a preference order among formats with the same payload size. In some aspects, if the values of N and M are known to the UE 120, the UE 120 may determine the selected format, of the formats configured for the UE 120, using the same rule or set of rules used by the network node 110 to select the selected format. In some aspects, such as in a case in which the values of N and/or M are not known to the UE 120, the network node 110 may use one or more additional bits to indicate the selected format of the formats configured for the UE 120.

In some cases, M (e.g., the total number of reference signals) may be known to both the network node 110 and the UE 120, but N (e.g., the number of selected reference signals to be measured by the UE 120) may only be known to the network node 110 and not known to the UE 120. In some aspects, in a case in which the value of N is not known to the UE 120, an indication of the value of N may be added to the indication of the N selected reference signals to be measured by the UE 120 from the set of M reference signals when Format 2 (e.g., the index reporting format), Format 2a (e.g., the modified index reporting format, or Format 3 (e.g., the combination index format) is used. The indication of the value of N may add ceiling(log₂M) bits when using Format 2, Format 2a, or Format 3. It can be noted that although the value of N could be indicated using ceiling(log₂N) bits, ceiling(log₂M) bits may be used because the value of N is not known to the UE 120. An indication of the value of N is not needed for Format 1 (e.g., the bitmap format) because Format 1 provides an indication of whether each of the M reference signals is selected.

Table 930 in FIG. 9B shows a comparison of payload size (e.g., quantity of bits) using Format 1, Format 2 or 2a (including the indication of N), and Format 3 (including the indication of N) to indicate N selected reference signals out of M total reference signals for different values of M and N. For example, using Format 1, the bit sequence for indicating the N selected reference signals may include a bitmap of length M. Using Format 2 or Format 2a, the bit sequence for indicating the N selected reference signals may include ceiling(log₂M) bits indicating the value of N followed by the bit sequence indicating the indices associated with the N selected reference signals. Using Format 3, the bit sequence for indicating the N selected reference signals may include ceiling(log₂M) bits indicating the value of N followed by the combination index indicating the combination of N selected reference signals out of the M reference signals.

Returning to FIG. 9A, as shown by reference number 920, the network node 110 may transmit, and the UE 120 may receive, configuration information indicating N selected reference signals to be measured by the UE 120 of a set of M reference signals. In some aspects, the configuration information may indicate an SSB transmission pattern. For example, the configuration information may indicate N SSBs, out of a set of M SSBs, that are to be transmitted by the network node 110 (e.g., and measured by the UE 120) in a certain time window. In some aspects, the configuration information may indicate N reference signals, out of M total reference signals (e.g., SSBs and/or CSI-RSs), to be measured for L1 RSRP and/or signal-to-interference-plus-noise ratio (SINR) reporting. In some aspects, the configuration information may indicate N reference signals (e.g., SSBs and/or CSI-RSs) to be measured for AI/ML based beam prediction. For example, the UE 120 may be configured to perform RSRP measurements on the N reference signals corresponding to the first set of beams and predict RSRP measurement values for a second set of beams based at least in part on the RSRP measurements of the N reference signals. In some aspects, the network node 110 may transmit the configuration information including the indication of the N selected reference signals to be measured by the UE 120 of the set of M reference signals via an RRC message, a MAC-CE, or DCI.

In some aspects, the network node 110 may use Format 3 (e.g., the bitmap format) to indicate the N selected reference signals to be measured by the UE 120 of the set of M reference signals. In some examples (e.g., when N is unknown to the UE 120), the indication of the N selected reference signals using Format 3 may include additional bits indicating the value of N. In such examples, the bit sequence for indicating the N selected reference signals may include ceiling(log₂M) bits indicating the value of N followed by the combination index indicating the combination of N selected reference signals out of the M reference signals. In some aspects, the network node 110 may use Format 2a (e.g., the modified index reporting format) to indicate the N selected reference signals to be measured by the UE 120 of the set of M reference signals. In some examples (e.g., when N is unknown to the UE 120), the indication of the N selected reference signals using Format 2a may include additional bits indicating the value of N. In such examples, the bit sequence for indicating the N selected reference signals may include ceiling(log₂M) bits indicating the value of N followed by the reference signal indices indicating the N selected reference signals. In some aspects, the network node 110 may use another format (e.g., Format 1, Format 2, the format associated with machine learning compression of the reference signal indices, or the format associated with Huffman coding of the reference signal indices, among other examples) to indicate the N selected reference signals to be measured by the UE 120 of the set of M reference signals.

In some aspects, if multiple formats for indicating selected reference signals are configured for the UE 120, the network node 110 may use the selected format determined as discussed in connection with reference number 915. In some aspects, the indication of the N selected reference signals to be measured by the UE 120 of the set of M reference signals may include one or more additional bits indicating the selected format. In some other aspects, if a single configured format for indicating selected reference signals is configured for the UE 120, the network node 110 may use the configured format. In some other aspects, the format for indicating the selected reference signals may be preconfigured (e.g., in accordance with a wireless communication standard) for the network node 110 and the UE 120.

As further shown in FIG. 9A, and by reference number 925, the UE 120 may transmit, and the network node 110 may receive, a measurement report associated with measurements of the N selected reference signals. In some aspects, the measurement report may include measurement values (e.g., RSRP and/or SINR measurement values) for the N selected reference signals. In some aspects, the measurement report may include measurement values (e.g., RSRP and/or SINR measurement values) for a subset of the N selected reference signals (e.g., a subset of K reference signals with highest RSRP and/or SINR values from the N reference signals measured by the UE 120). In such examples, the measurement report may indicate the K reference signals selected from the N measured reference signals using a format for indicating selected reference signals (e.g., the same format or a different format as used in the configuration information for indicating the N selected reference signals to be measured from the M total reference signals), as discussed in connection with FIGS. 10A-10C. In some aspects, the N selected reference signals may correspond to a first set of beams, and the measurement report may include predicted measurement values (e.g., RSRP and/or SINR measurement values) for a second set of beams determined based at least in part on the measurements of the N selected reference signals.

The UE 120 may determine the N selected reference signals to be measured based at least in part on the format used for indicating the N selected reference signals in the configuration information. For example, the UE 120 may decode the indication of the N selected reference signals based at least in part on the format used to indicate the N selected reference signals. The UE 120 may then perform measurements (e.g., RSRP and/or SINR measurements) of the N selected reference signals and generate the measurement report. In some aspects, if multiple formats for indicating selected reference signals are configured for the UE 120 and the values for M and N are known to the UE 120, the UE 120 may determine the selected format used by the network node 110 in the configuration information to indicate the N selected reference signals based at least in part on payload sizes associated with the formats configured for the UE 120. For example, the UE 120 may determine the payload sizes associated with the multiple formats configured for the UE 120 based at least in part on M and N, determine the selected format used in the configuration information based at least in part on the payload sizes (e.g., using the same rule or set of rules as used by the network node 110 to select the selected format), and determine the N selected reference signals to be measured based at least in part on the selected format. In some aspects, the configuration information may indicate the selected format used to indicate the N selected reference signals.

As indicated above, FIGS. 9A-9B are provided as an example. Other examples may differ from what is described with respect to FIGS. 9A-9B.

FIGS. 10A-10C are diagrams illustrating an example 1000 associated with formats for indicating selected reference signals, in accordance with the present disclosure. As shown in FIG. 10A, example 1000 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 10A, and by reference number 1005, in some aspects, the UE 120 may transmit, and the network node 110 may receive, UE capability information indicating a capability of the UE 120 associated with one or more formats for indicating selected reference signals. In some aspects, the UE capability information may indicate one or more supported formats for indicating selected reference signals (e.g., one or more formats for indicating selected reference signals that are supported by the UE 120). In some aspects, the capability information may indicate that the UE 120 supports Format 3 (e.g., the combination index format) discussed in connection with FIG. 7. In some aspects, the capability information may indicate that the UE 120 supports Format 2A (e.g., the modified index reporting format) discussed in connection with FIG. 6.

In some aspects, the one or more supported formats indicated by the capability information may include one or more of Format 1 (e.g., the bitmap format), Format 2 (e.g., the index reporting format), Format 2a (e.g., the modified index reporting format), Format 3 (e.g., the combination index format), a format associated with machine learning compression of indices associated with selected reference signals, and/or a format associated with Huffman coding of indices associated with selected reference signals, among other examples. For example, different formats may require different levels of computational power, and different formats may be supported by different UEs.

As further shown in FIG. 10A, and by reference number 1010, in some aspects, the network node 110 may transmit, and the UE 120 may receive, configuration information indicating one or more formats for indicating selected reference signals that are configured for the UE 120. For example, the one or more formats indicated in the configuration information may be based at least in part on the one or more supported formats indicated in the capability information.

In some aspects, the configuration information may indicate a configured format (a single configured format) for indicating selected reference signals. For example, the configuration information may indicate a configured format that is to be used by the UE 120 for indicating K reference signals for which measurements are reported out of N reference signals measured by the UE 120. In some examples, the configured format may be Format 3 (e.g., the combination index format). In some examples, the configured format may be Format 2a (e.g., the modified index reporting format). In some other examples, the configured format may be another format (e.g., Format 1, Format 2, the format associated with machine learning compression of reference signal indices, or the format associated with Huffman coding of reference signal indices, among other examples).

In some aspects, the configuration information may indicate multiple formats for indicating selected reference signals. In such examples, the UE 120 may be configured with multiple formats for indicating selected reference signals. For example, the configuration information may indicate multiple formats from the supported formats indicated in the UE capability information. In some examples, the configuration information may indicate one or more of Format 1 (e.g., the bitmap format), Format 2 (e.g., the index reporting format), Format 2a (e.g., the modified index reporting format), Format 3 (e.g., the combination index format), the format associated with machine learning compression of indices associated with selected reference signals, and/or the format associated with Huffman coding of indices associated with selected reference signals, among other examples.

As further shown in FIG. 10A, and by reference number 1015, the network node 110 may transmit, and the UE 120 may receive, configuration information indicating that the UE 120 is to measure N reference signals and report K reference signals. For example, the configuration information may configure L1 RSRP and/or SINR reporting by the UE 120. In such examples, the configuration information may indicate that the UE 120 is to measure N reference signals (e.g., SSBs and/or CSI-RSs) and report measurement values (e.g., RSRP and/or SINR measurement values) for K selected reference signals of the N reference signals (e.g., the K reference signals with the strongest RSRP and/or SINR measurements) as well as an indication of the K reference signals for which the measurement values are reported. The configuration information may indicate the value of K, but may not identify which K reference signals of the N reference signals to be measured by the UE 120 are to be reported. In some examples, the configuration information may indicate that the UE 120 is to measure N reference signals from a set of M total reference signals, as discussed in connection with FIGS. 9A-9B.

As further shown in FIG. 10A, and by reference number 1020, in some aspects, the UE 120 may select a format for indicating selected reference signals. For example, in a case in which multiple formats are configured for the UE 120, the UE 120 may select the format from the multiple formats configured for the UE 120. In some examples, the UE 120 may select the format to be used for indicating K selected reference signals being reported out of N measured reference signals. For example, the UE 120 may select the format to use for each indication of K selected reference signals being reported out of the N measured reference signals based at least in part on the values of K and N and based at least in part on the formats configured for the UE 120.

In some aspects, the UE 120 may select the format to be used for indicating K selected reference signals being reported from N measured reference signals based at least in part on payload sizes associated with the formats configured for the UE 120 using a rule or set of rules (e.g., a preconfigured rule or set of rules). For example, the UE 120 may determine a payload size (e.g., a quantity of bits to be used) associated with each of the formats configured for the UE 120 based at least in part on the values of K and N, and the UE 120 may select a format with a smallest payload size. If multiple formats have the same smallest payload size, then the UE 120 may select from the multiple formats having the same payload size based at least in part on a rule (e.g., a preconfigured rule) that establishes a preference order among formats with the same payload size. In some aspects, the values of K and N may be known to the network node 110, and the network node 110 may determine the selected format, of the formats configured for the UE 120, using the same rule or set of rules used by the UE 120 to select the selected format.

In some aspects, such as in a case in which the payload sizes for any of the configured formats cannot be known to the network node 110, the UE 120 may use one or more additional bits to indicate the selected format of the formats configured for the UE 120. For example, in a case in which both Format 3 (e.g., the combination index format) and the format associated with machine learning compression of reference signal indices are configured for the UE 120, the payload of using the machine learning compression format for the selected reference signal indices may not be known before the measurements of the N reference signals are performed. In such examples, the UE 120 selects the format with smallest payload, and the network node 110 may not know which format is selected by the UE 120. In this case, the UE 120 may use an additional bit with a first value (e.g., 0) to indicate that Format 3 is used, or an additional bit with a second value (e.g., 1) to indicate that the format associated with machine learning compression of the reference signal indices is used for the current measurement report.

As further shown in FIG. 10A, and by reference number 1025, the UE 120 may transmit, and the network node 110 may receive, a measurement report indicating K selected reference signals of the N reference signals. The UE 120 may measure the N reference signals (e.g., SSBs and/or CSI-RSs) and select the K reference signals to be reported based at least in part on the measurements of the N reference signals. For example, the UE 120 may report measurement values for the K reference signals having the highest RSRP and/or SINR measurements. The measurement report may include measurement values (e.g., RSRP and/or SINR values) for the K selected reference signals and an indication of the K selected reference signals of the N measured reference signals. In some examples, for L1 RSRP/SINR reporting, N≥K and K may be less than or equal to 4. In some other examples, greater values for K may be configured.

In some aspects, the UE 120 may use Format 3 (e.g., the bitmap format) to indicate the K selected reference signals of the N measured reference signals. In some aspects, the network node 110 may use Format 2a (e.g., the modified index reporting format) to indicate the K selected reference signals of the N measured reference signals. In some aspects, the network node 110 may use another format (e.g., Format 1, Format 2, the format associated with machine learning compression of the reference signal indices, or the format associated with Huffman coding of the reference signal indices, among other examples) to indicate the K selected reference signals to be measured by the UE 120 of the set of N reference signals. In some aspects, if multiple formats for indicating selected reference signals are configured for the UE 120, the UE 120 may use the selected format determined as discussed in connection with reference number 1020. In some aspects, the indication of the K selected reference signals of the N measured reference signals in the measurement report may include one or more additional bits indicating the selected format. In some other aspects, if a single configured format for indicating selected reference signals is configured for the UE 120, the UE 120 may use the configured format. In some other aspects, the format for indicating the selected reference signals may be preconfigured (e.g., in accordance with a wireless communication standard) for the network node 110 and the UE 120.

In some aspects, differential reporting may be used for the measurement values (e.g., RSRP and/or SINR measurement values) included in the measurement report. In such examples, the strongest RSRP/SINR value is reported using an absolute value (e.g., using 7 bits for an RSRP value), and the other RSRP/SINR values are reported using differential values with respect to the strongest RSRP/SINR value. When Format 2 (e.g., the index reporting format) or Format 2a (e.g., the modified index reporting format) is used, the first reference signal index encoded may correspond to the reference signal with the strongest (e.g., highest) measurement value (e.g., RSRP and/or SINR measurement value). In some aspects, when Format 3 (e.g., the combination index format) or Format 1 (e.g., the bitmap format) is used for L1 RSRP/SINR reporting, the measurement report may further include an indication of an index of the reference signal with a strongest measurement value (e.g., RSRP and/or SINR measurement value) among the K selected reference signals.

In some aspects, for Format 1, ceiling(log₂K) bits may be used to indicate the index of the reference signal with the strongest measurement value. In such examples, the total number of bits used to indicate the K selected reference signals of the N reference signals may be ceiling(log₂K)+N. In some aspects, in a first option for Format 3 (referred to herein as “Format 3a”), ceiling(log₂K)bits may be used to indicate the index of the reference signal with the strongest measurement value out of the K selected reference signals, and a combination index indicating a combination of K reference signals out of the N reference signals may be used to indicate the selection of the K reference signals. In such examples, the total number of bits used to indicate the K selected reference signals of the N reference signals may be ceiling(log₂K)+ceiling(log₂(C(N, K)). In some aspects, in a second option for Format 3 (referred to herein as “Format 3b”), ceiling(log₂N)bits may be used to indicate the index of the reference signal with the strongest measurement value out of the K selected reference signals, and a combination index indicating a combination of K−1 remaining selected reference signals (e.g., other than the reference signal having the strongest measurement value) out of the N−1 remaining measured reference signals (e.g., other than the reference signal having the strongest measurement value) may be used to indicate the selection of the K−1 remaining selected reference signals. In such examples, the total number of bits used to indicate the K selected reference signals of the N reference signals may be ceiling(log₂N)+ceiling(log₂(C(N−1, K−1)).

FIG. 10B shows example bit sequences for L1 RSRP reporting using Format 1, Format 2 or 2a, and Format 3. As shown by reference number 1030, for Format 1, the bit sequence may include ceiling(log₂K) bits indicating the reference signal with the strongest RSRP value among the K selected reference signals, a bitmap indicating the K selected reference signals of the N measured reference signals, and the RSRP values for the K selected reference signals. As shown by reference number 1035, for Format 2 or 2a, the bit sequence may include an index associated with the reference signal with the strongest RSRP value among the K selected reference signals, the indices associated with the remaining reference signals of the K selected reference signals, and the RSRP values for the K selected reference signals.

As shown by reference number 1040, in Format 3a, the bit sequence may include ceiling(log₂K) bits indicating the reference signal with the strongest RSRP value among the K selected reference signals, a combination index indicating the combination of the K selected reference signals of the N reference signals (e.g., an index to a table of C(N, K) indicating the K selected reference signals), and the RSRP values for the K selected reference signals. As shown by reference number 1045, in Format 3b, the bit sequence may include ceiling(log₂N) bits indicating the reference signal with the strongest RSRP value among the K selected reference signals, a combination index indicating a combination of the K−1 remaining selected reference signals (e.g., other than the reference signal with the strongest RSRP value) of the N−1 remaining reference signals (e.g., an index to a table of C(N−1, K−1) indicating the K−1 remaining selected reference signals), and the RSRP values for the K selected reference signals.

Table 1050 in FIG. 10C shows a comparison of payload size (e.g., quantity of bits) for indicating the K selected reference signals of the N measured reference signals using Format 1 (including the indication of the reference signal with the strongest measurement value), Format 2, Format 2a, Format 3a, and Format 3b.

When using Format 2 or Format 2a, the order of the measurement values (e.g., RSRP and/or SINR values) in the measurement report may be the same as the order of the indices associated with the K selected reference signals. In some aspects, when using Format 3 or Format 1, the measurement report may indicate the measurement values (e.g., RSRP and/or SINR values) in ascending order of the reference signal indices associated with the K selected reference signals. In some aspects, when using Format 3 or Format 1, the measurement report may indicate the measurement values (e.g., RSRP and/or SINR values) in descending order of the reference signal indices associated with the K selected reference signals. In some aspects, when using Format 3 or Format 1, the measurement report may indicate the strongest measurement value, among the measurement values for the K selected reference signals, first, followed by the remaining measurement values for the rest of the K selected reference signals in ascending order of the reference signal indices associated with remaining ones of the K selected reference signals. In some aspects, when using Format 3 or Format 1, the measurement report may indicate the strongest measurement value, among the measurement values for the K selected reference signals, first, followed by the remaining measurement values for the rest of the K selected reference signals in descending order of the reference signal indices associated with remaining ones of the K selected reference signals.

The network node 110 may determine the K selected reference signals for which measurement values are reported based at least in part on the format used for indicating the K selected reference signals in the measurement report. For example, the network node 110 may decode the indication of the K selected reference signals based at least in part on the format used to indicate the K selected reference signals. In some aspects, if multiple formats for indicating selected reference signals are configured for the UE 120, the network node 110 may determine the selected format used by the UE 120 in the measurement report to indicate the K selected reference signals based at least in part on payload sizes associated with the formats configured for the UE 120. For example, the network node 110 may determine the payload sizes associated with the multiple formats configured for the UE 120 based at least in part on N and K, determine the selected format used in the measurement report based at least in part on the payload sizes (e.g., using the same rule or set of rules as used by the UE 120 to select the selected format), and determine the K selected reference signals for which measurement values are reported based at least in part on the selected format. In some aspects, such as in a case in which the payload sizes for any of the configured formats cannot be known to the network node 110, the measurement report may indicate the selected format used to indicate the K selected reference signals.

As indicated above, FIGS. 10A-10C are provided as an example. Other examples may differ from what is described with respect to FIGS. 10A-10C.

FIG. 11 is a diagram illustrating an example process 1100 performed, for example, by a UE, in accordance with the present disclosure. Example process 1100 is an example where the UE (e.g., UE 120) performs operations associated with formats for indicating beam indices.

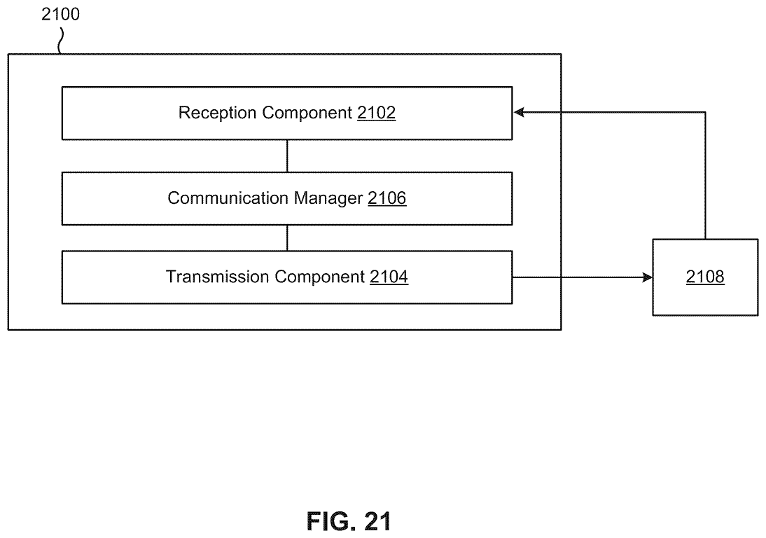

As shown in FIG. 11, in some aspects, process 1100 may include receiving, from a network node, configuration information indicating that the UE is to measure N reference signals and report K reference signals, wherein N and K are integers (block 1110). For example, the UE (e.g., using reception component 2102 and/or communication manager 2106, depicted in FIG. 21) may receive, from a network node, configuration information indicating that the UE is to measure N reference signals and report K reference signals, wherein N and K are integers, as described above.

As further shown in FIG. 11, in some aspects, process 1100 may include transmitting, to the network node, a measurement report indicating a combination index associated with K selected reference signals of the N reference signals and measurement values for the K selected reference signals (block 1120). For example, the UE (e.g., using transmission component 2104 and/or communication manager 2106, depicted in FIG. 21) may transmit, to the network node, a measurement report indicating a combination index associated with K selected reference signals of the N reference signals and measurement values for the K selected reference signals, as described above.

Process 1100 may include additional aspects, such as any single aspect or any combination of aspects described below and/or in connection with one or more other processes described elsewhere herein.

In a first aspect, the measurement report includes an indication of an index of a reference signal with a strongest measurement value among the K selected reference signals, and the combination index indicates a combination of the K selected reference signals of the N reference signals.

In a second aspect, alone or in combination with the first aspect, the measurement report includes an indication of an index of a reference signal with a strongest measurement value among the N reference signals, and the combination index indicates a combination of K−1 remaining selected reference signals, other than the reference signal with the strongest measurement value, of N−1 remaining reference signals other than the reference signal with the strongest measurement value.

In a third aspect, alone or in combination with one or more of the first and second aspects, the measurement values for the K selected reference signals include RSRP values or SINR values for the K selected reference signals.

In a fourth aspect, alone or in combination with one or more of the first through third aspects, the measurement report indicates the measurement values for the K selected reference signals in ascending or descending order of respective reference signal indices associated with the K selected reference signals.

In a fifth aspect, alone or in combination with one or more of the first through fourth aspects, the measurement report indicates a strongest measurement value, among the measurement values for the K selected reference signals, first, followed by remaining measurement values, among the measurement values for the K selected reference signals in ascending or descending order of respective reference signal indices associated with the K selected reference signals.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with formats for indicating beam indices.

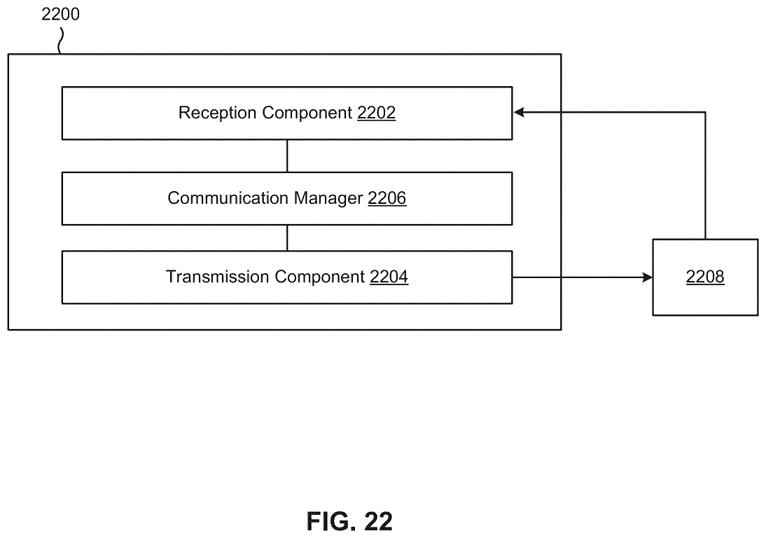

As shown in FIG. 12, in some aspects, process 1200 may include transmitting, to a UE, configuration information indicating that the UE is to measure N reference signals and report K reference signals, wherein N and K are integers (block 1210). For example, the network node (e.g., using transmission component 2204 and/or communication manager 2206, depicted in FIG. 22) may transmit, to a UE, configuration information indicating that the UE is to measure N reference signals and report K reference signals, wherein N and K are integers, as described above.

As further shown in FIG. 12, in some aspects, process 1200 may include receiving, from the UE, a measurement report indicating a combination index associated with K selected reference signals of the N reference signals and measurement values for the K selected reference signals (block 1220). For example, the network node (e.g., using reception component 2202 and/or communication manager 2206, depicted in FIG. 22) may receive, from the UE, a measurement report indicating a combination index associated with K selected reference signals of the N reference signals and measurement values for the K selected reference signals, as described above.

Process 1200 may include additional aspects, such as any single aspect or any combination of aspects described below and/or in connection with one or more other processes described elsewhere herein.

In a first aspect, the measurement report includes an indication of an index of a reference signal with a strongest measurement value among the K selected reference signals, and the combination index indicates a combination of the K selected reference signals of the N reference signals.

In a second aspect, alone or in combination with the first aspect, the measurement report includes an indication of an index of a reference signal with a strongest measurement value among the N reference signals, and the combination index indicates a combination of K−1 remaining selected reference signals, other than the reference signal with the strongest measurement value, of N−1 remaining reference signals other than the reference signal with the strongest measurement value.

In a third aspect, alone or in combination with one or more of the first and second aspects, the measurement values for the K selected reference signals include RSRP values or SINR values for the K selected reference signals.

In a fourth aspect, alone or in combination with one or more of the first through third aspects, the measurement report indicates the measurement values for the K selected reference signals in ascending or descending order of respective reference signal indices associated with the K selected reference signals.

In a fifth aspect, alone or in combination with one or more of the first through fourth aspects, the measurement report indicates a strongest measurement value, among the measurement values for the K selected reference signals, first, followed by remaining measurement values, among the measurement values for the K selected reference signals in ascending or descending order of respective reference signal indices associated with the K selected reference signals.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120) performs operations associated with formats for indicating beam indices.

As shown in FIG. 13, in some aspects, process 1300 may include receiving, from a network node, configuration information indicating that the UE is to measure N reference signals and report K reference signals, wherein N and K are integers (block 1310). For example, the UE (e.g., using reception component 2102 and/or communication manager 2106, depicted in FIG. 21) may receive, from a network node, configuration information indicating that the UE is to measure N reference signals and report K reference signals, wherein N and K are integers, as described above.

As further shown in FIG. 13, in some aspects, process 1300 may include transmitting, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals (block 1320). For example, the UE (e.g., using transmission component 2104 and/or communication manager 2106, depicted in FIG. 21) may transmit, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals, as described above.

Process 1300 may include additional aspects, such as any single aspect or any combination of aspects described below and/or in connection with one or more other processes described elsewhere herein.

In a first aspect, the measurement report indicates a respective reference signal index value for a reference signal with a strongest measurement value among the K selected reference signals first, followed by respective reference signal index values for remaining reference signals, of the K selected reference signals, other than the reference signal with the strongest measurement value.

In a second aspect, alone or in combination with the first aspect, the measurement values for the K selected reference signals include RSRP values or SINR values for the K selected reference signals.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 110) performs operations associated with formats for indicating beam indices.

As shown in FIG. 14, in some aspects, process 1400 may include transmitting, to a UE, configuration information indicating that the UE is to measure N reference signals and report K reference signals, wherein N and K are integers (block 1410). For example, the network node (e.g., using transmission component 2204 and/or communication manager 2206, depicted in FIG. 22) may transmit, to a UE, configuration information indicating that the UE is to measure N reference signals and report K reference signals, wherein N and K are integers, as described above.

As further shown in FIG. 14, in some aspects, process 1400 may include receiving, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals (block 1420). For example, the network node (e.g., using reception component 2202 and/or communication manager 2206, depicted in FIG. 22) may receive, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals, as described above.

Process 1400 may include additional aspects, such as any single aspect or any combination of aspects described below and/or in connection with one or more other processes described elsewhere herein.

In a first aspect, the measurement report indicates a respective reference signal index value for a reference signal with a strongest measurement value among the K selected reference signals first, followed by respective reference signal index values for remaining reference signals, of the K selected reference signals, other than the reference signal with the strongest measurement value.

In a second aspect, alone or in combination with the first aspect, the measurement values for the K selected reference signals include RSRP values or SINR values for the K selected reference signals.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120) performs operations associated with formats for indicating beam indices.

As shown in FIG. 15, in some aspects, process 1500 may include receiving, from a network node, configuration information indicating a combination index that corresponds to N selected reference signals, from a set of M reference signals, to be measured by the UE, wherein N and M are integers (block 1510). For example, the UE (e.g., using reception component 2102 and/or communication manager 2106, depicted in FIG. 21) may receive, from a network node, configuration information indicating a combination index that corresponds to N selected reference signals, from a set of M reference signals, to be measured by the UE, wherein N and M are integers, as described above.

As further shown in FIG. 15, in some aspects, process 1500 may include transmitting, to the network node, a measurement report associated with measurements of the N selected reference signals (block 1520). For example, the UE (e.g., using transmission component 2104 and/or communication manager 2106, depicted in FIG. 21) may transmit, to the network node, a measurement report associated with measurements of the N selected reference signals, as described above.

Process 1500 may include additional aspects, such as any single aspect or any combination of aspects described below and/or in connection with one or more other processes described elsewhere herein.

In a first aspect, the configuration information includes an indication of a value of N.

In a second aspect, alone or in combination with the first aspect, the measurement report indicates predicted measurement values for a set of beams based at least in part on the measurements of the N selected reference signals.

In a third aspect, alone or in combination with one or more of the first and second aspects, the measurement report indicates RSRP or SINR values associated with the measurements of the N selected reference signals.

In a fourth aspect, alone or in combination with one or more of the first through third aspects, the N selected reference signals are associated with an SSB transmission pattern.

In a fifth aspect, alone or in combination with one or more of the first through fifth aspects, the measurement report indicates measurement values for K reference signals of the N selected reference signals, wherein K is an integer.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a network node, in accordance with the present disclosure. Example process 1600 is an example where the network node (e.g., network node 110) performs operations associated with formats for indicating beam indices.

As shown in FIG. 16, in some aspects, process 1600 may include transmitting, to a UE, configuration information indicating a combination index that corresponds to N selected reference signals, from a set of M reference signals, to be measured by the UE, wherein N and M are integers (block 1610). For example, the network node (e.g., using transmission component 2204 and/or communication manager 2206, depicted in FIG. 22) may transmit, to a UE, configuration information indicating a combination index that corresponds to N selected reference signals, from a set of M reference signals, to be measured by the UE, wherein M and N are integers, as described above.

As further shown in FIG. 16, in some aspects, process 1600 may include receiving, from the UE, a measurement report associated with measurements of the N selected reference signals (block 1620). For example, the network node (e.g., using reception component 2202 and/or communication manager 2206, depicted in FIG. 22) may receive, from the UE, a measurement report associated with measurements of the N selected reference signals, as described above.

Process 1600 may include additional aspects, such as any single aspect or any combination of aspects described below and/or in connection with one or more other processes described elsewhere herein.

In a first aspect, the configuration information includes an indication of a value of N.

In a second aspect, alone or in combination with the first aspect, the measurement report indicates predicted measurement values for a set of beams based at least in part on the measurements of the N selected reference signals.

In a third aspect, alone or in combination with one or more of the first and second aspects, the measurement report indicates RSRP or SINR values associated with the measurements of the N selected reference signals.

In a fourth aspect, alone or in combination with one or more of the first through third aspects, the N selected reference signals are associated with an SSB transmission pattern.

In a fifth aspect, alone or in combination with one or more of the first through fifth aspects, the measurement report indicates measurement values for K reference signals of the N selected reference signals, wherein K is an integer.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a UE, in accordance with the present disclosure. Example process 1700 is an example where the UE (e.g., UE 120) performs operations associated with formats for indicating beam indices.

As shown in FIG. 17, in some aspects, process 1700 may include receiving, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals (block 1710). For example, the UE (e.g., using reception component 2102 and/or communication manager 2106, depicted in FIG. 21) may receive, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals, as described above.

As further shown in FIG. 17, in some aspects, process 1700 may include transmitting, to the network node, a measurement report associated with measurements of the N selected reference signals (block 1720). For example, the UE (e.g., using transmission component 2104 and/or communication manager 2106, depicted in FIG. 21) may transmit, to the network node, a measurement report associated with measurements of the N selected reference signals, as described above.

Process 1700 may include additional aspects, such as any single aspect or any combination of aspects described below and/or in connection with one or more other processes described elsewhere herein.

In a first aspect, the configuration information includes an indication of a value of N.

In a second aspect, alone or in combination with the first aspect, the measurement report indicates predicted measurement values for a set of beams based at least in part on the measurements of the N selected reference signals.

In a third aspect, alone or in combination with one or more of the first and second aspects, the measurement report indicates RSRP or SINR values associated with the measurements of the N selected reference signals.

In a fourth aspect, alone or in combination with one or more of the first through third aspects, the N selected reference signals are associated with an SSB transmission pattern.

In a fifth aspect, alone or in combination with one or more of the first through fifth aspects, the measurement report indicates measurement values for K reference signals of the N selected reference signals, wherein K is an integer.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a network node, in accordance with the present disclosure. Example process 1800 is an example where the network node (e.g., network node 110) performs operations associated with formats for indicating beam indices.

As shown in FIG. 18, in some aspects, process 1800 may include transmitting, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals (block 1810). For example, the network node (e.g., using transmission component 2204 and/or communication manager 2206, depicted in FIG. 22) may transmit, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals, as described above.

As further shown in FIG. 18, in some aspects, process 1800 may include receiving, from the UE, a measurement report associated with measurements of the N selected reference signals (block 1820). For example, the network node (e.g., using reception component 2202 and/or communication manager 2206, depicted in FIG. 22) may receive, from the UE, a measurement report associated with measurements of the N selected reference signals, as described above.

Process 1800 may include additional aspects, such as any single aspect or any combination of aspects described below and/or in connection with one or more other processes described elsewhere herein.

In a first aspect, the configuration information includes an indication of a value of N.

In a second aspect, alone or in combination with the first aspect, the measurement report indicates predicted measurement values for a set of beams based at least in part on the measurements of the N selected reference signals.

In a third aspect, alone or in combination with one or more of the first and second aspects, the measurement report indicates RSRP or SINR values associated with the measurements of the N selected reference signals.

In a fourth aspect, alone or in combination with one or more of the first through third aspects, the K selected reference signals are associated with an SSB transmission pattern.

In a fifth aspect, alone or in combination with one or more of the first through fifth aspects, the measurement report indicates measurement values for K reference signals of the N selected reference signals, wherein K is an integer.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a UE, in accordance with the present disclosure. Example process 1900 is an example where the UE (e.g., UE 120) performs operations associated with formats for indicating beam indices.

As shown in FIG. 19, in some aspects, process 1900 may include receiving, from a network node, configuration information indicating one or more formats for indicating selected reference signals (block 1910). For example, the UE (e.g., using reception component 2102 and/or communication manager 2106, depicted in FIG. 21) may receive, from a network node, configuration information indicating one or more formats for indicating selected reference signals, as described above.

As further shown in FIG. 19, in some aspects, process 1900 may include communicating with the network node based at least in part on the one or more formats for indicating selected reference signals (block 1920). For example, the UE (e.g., using reception component 2102, transmission component 2104, and/or communication manager 2106, depicted in FIG. 21) may communicate with the network node based at least in part on the one or more formats for indicating selected reference signals, as described above.

Process 1900 may include additional aspects, such as any single aspect or any combination of aspects described below and/or in connection with one or more other processes described elsewhere herein.

In a first aspect, process 1900 includes transmitting, to the network node, capability information indicating one or more supported formats for indicating selected reference signals, wherein the one or more formats for indicating selected reference signals are based at least in part on the capability information.

In a second aspect, alone or in combination with the first aspect, the configuration information indicates a configured format for indicating selected reference signals.

In a third aspect, alone or in combination with one or more of the first and second aspects, communicating with the network node includes transmitting, to the network node, a measurement report indicating K selected reference signals of N measured reference signals using the configured format for indicating selected reference signals, wherein K and N are integers.

In a fourth aspect, alone or in combination with one or more of the first through third aspects, communicating with the network node includes receiving, from the network node, an indication of N selected reference signals, of a set of M reference signals, to be measured by the UE, the indication of the N selected reference signals using the configured format for indicating selected reference signals, wherein N and M are integers.

In a fifth aspect, alone or in combination with one or more of the first through fourth aspects, the configuration information indicates a plurality of formats for indicating selected reference signals.

In a sixth aspect, alone or in combination with one or more of the first through fifth aspects, communicating with the network node includes transmitting, to the network node, a measurement report indicating K selected reference signals of N measured reference signals using a selected format of the plurality of formats for indicating selected reference signals, wherein K and N are integers.

In a seventh aspect, alone or in combination with one or more of the first through sixth aspects, process 1900 includes selecting the selected format of the plurality of formats based at least in part on report payload sizes associated with the plurality of formats for indicating selected reference signals.

In an eighth aspect, alone or in combination with one or more of the first through seventh aspects, the selected format is a format associated with a smallest report payload size among the plurality of formats for indicating selected reference signals.

In a ninth aspect, alone or in combination with one or more of the first through eighth aspects, the measurement report includes an indication of the selected format of the plurality of formats for indicating selected reference signals.

In a tenth aspect, alone or in combination with one or more of the first through ninth aspects, communicating with the network node includes receiving, from the network node, an indication of N selected reference signals, of a set of M reference signals, to be measured by the UE, the indication of the N selected reference signals using a selected format of the plurality of formats for indicating selected reference signals, wherein N and M are integers.

In an eleventh aspect, alone or in combination with one or more of the first through tenth aspects, process 1900 includes determining payload sizes associated with the plurality of formats for indicating selected reference signals based at least in part on M and N, determining the selected format used for the indication of the N selected reference signals based at least in part on the payload sizes associated with the plurality of formats for indicating selected reference signals, and determining the N selected reference signals to be measured by the UE based at least in part on the determination of the selected format used for the indication of the N selected reference signals.

In a twelfth aspect, alone or in combination with one or more of the first through eleventh aspects, the indication of the N selected reference signals includes an indication of the selected format the plurality of formats for indicating selected reference signals.

In a thirteenth aspect, alone or in combination with one or more of the first through twelfth aspects, the one or more formats for indicating selected reference signals include one or more of a first format associated with a bitmap for indicating selected reference signals, a second format associated with indicating indices associated with selected reference signals, a third format associated with a combination index for indicating a combination of selected reference signals, a fourth format associated with machine learning compression of indices associated with selected reference signals, or a fifth format associated with Huffman coding of indices associated with selected reference signals.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a network node, in accordance with the present disclosure. Example process 2000 is an example where the network node (e.g., network node 110) performs operations associated with formats for indicating beam indices.

As shown in FIG. 20, in some aspects, process 2000 may include transmitting, to a UE, configuration information indicating one or more formats for indicating selected reference signals (block 2010). For example, the network node (e.g., using transmission component 2204 and/or communication manager 2206, depicted in FIG. 22) may transmit, to a UE, configuration information indicating one or more formats for indicating selected reference signals, as described above.

As further shown in FIG. 20, in some aspects, process 2000 may include communicating with the UE based at least in part on the one or more formats for indicating selected reference signals (block 2020). For example, the network node (e.g., using reception component 2202, transmission component 2204, and/or communication manager 2206, depicted in FIG. 22) may communicate with the UE based at least in part on the one or more formats for indicating selected reference signals, as described above.

Process 2000 may include additional aspects, such as any single aspect or any combination of aspects described below and/or in connection with one or more other processes described elsewhere herein.

In a first aspect, process 2000 includes receiving, from the UE, capability information indicating one or more supported formats for indicating selected reference signals, wherein the one or more formats for indicating selected reference signals are based at least in part on the capability information.

In a second aspect, alone or in combination with the first aspect, the configuration information indicates a configured format for indicating selected reference signals.

In a third aspect, alone or in combination with one or more of the first and second aspects, communicating with the UE includes receiving, from the UE, a measurement report indicating K selected reference signals of N measured reference signals using the configured format for indicating selected reference signals, wherein K and N are integers.

In a fourth aspect, alone or in combination with one or more of the first through third aspects, communicating with the UE includes transmitting, to the UE, an indication of N selected reference signals, of a set of M reference signals, to be measured by the UE, the indication of the N selected reference signals using the configured format for indicating selected reference signals, wherein N and M are integers.

In a fifth aspect, alone or in combination with one or more of the first through fourth aspects, the configuration information indicates a plurality of formats for indicating selected reference signals.

In a sixth aspect, alone or in combination with one or more of the first through fifth aspects, communicating with the UE includes transmitting, to the UE, an indication of N selected reference signals, of a set of M reference signals, to be measured by the UE, the indication of the N selected reference signals using a selected format of the plurality of formats for indicating selected reference signals, wherein N and M are integers.

In a seventh aspect, alone or in combination with one or more of the first through sixth aspects, process 2000 includes selecting the selected format of the plurality of formats based at least in part on payload sizes associated with the plurality of formats for indicating selected reference signals.

In an eighth aspect, alone or in combination with one or more of the first through seventh aspects, the selected format is a format associated with a smallest payload size among the plurality of formats for indicating selected reference signals.

In a ninth aspect, alone or in combination with one or more of the first through eighth aspects, the indication of the N selected reference signals includes an indication of the selected format of the plurality of formats for indicating selected reference signals.

In a tenth aspect, alone or in combination with one or more of the first through ninth aspects, communicating with the UE includes receiving, from the UE, a measurement report indicating K selected reference signals of N measured reference signals using a selected format of the plurality of formats for indicating selected reference signals, wherein K and N are integers.

In an eleventh aspect, alone or in combination with one or more of the first through tenth aspects, process 2000 includes determining report payload sizes associated with the plurality of formats for indicating selected reference signals based at least in part on N and K, determining the selected format used for indicating the K selected reference signals indicated in the measurement report based at least in part on the report payload sizes associated with the plurality of formats for indicating selected reference signals, and determining the K selected reference signals indicated in the measurement report based at least in part on the determination of the selected format used for the measurement report.

In a twelfth aspect, alone or in combination with one or more of the first through eleventh aspects, the measurement report includes an indication of the selected format the plurality of formats for indicating selected reference signals.

In a thirteenth aspect, alone or in combination with one or more of the first through twelfth aspects, the one or more formats for indicating selected reference signals include one or more of a first format associated with a bitmap for indicating selected reference signals, a second format associated with indicating indices associated with selected reference signals, a third format associated with a combination index for indicating a combination of selected reference signals, a fourth format associated with machine learning compression of indices associated with selected reference signals, or a fifth format associated with Huffman coding of indices associated with selected reference signals.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram of an example apparatus 2100 for wireless communication, in accordance with the present disclosure. The apparatus 2100 may be a UE, or a UE may include the apparatus 2100. In some aspects, the apparatus 2100 includes a reception component 2102, a transmission component 2104, and/or a communication manager 2106, which may be in communication with one another (for example, via one or more buses and/or one or more other components). In some aspects, the communication manager 2106 is the communication manager 140 described in connection with FIG. 1. As shown, the apparatus 2100 may communicate with another apparatus 2108, such as a UE or a network node (such as a CU, a DU, an RU, or a base station), using the reception component 2102 and the transmission component 2104.

In some aspects, the apparatus 2100 may be configured to perform one or more operations described herein in connection with FIGS. 4-8, 9A-9B, and 10A-10C. Additionally, or alternatively, the apparatus 2100 may be configured to perform one or more processes described herein, such as process 1100 of FIG. 11, process 1300 of FIG. 13, process 1500 of FIG. 15, process 1700 of FIG. 17, process 1900 of FIG. 19, or a combination thereof. In some aspects, the apparatus 2100 and/or one or more components shown in FIG. 21 may include one or more components of the UE described in connection with FIG. 2. Additionally, or alternatively, one or more components shown in FIG. 21 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2108. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a demodulator, a MIMO detector, a receive processor, a controller/processor, a memory, or a combination thereof, of the UE described in connection with FIG. 2.

The transmission component 2104 may transmit communications, such as reference signals, control information, data communications, or a combination thereof, to the apparatus 2108. In some aspects, one or more other components of the apparatus 2100 may generate communications and may provide the generated communications to the transmission component 2104 for transmission to the apparatus 2108. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2108. In some aspects, the transmission component 2104 may include one or more antennas, a modem, a modulator, a transmit MIMO processor, a transmit processor, a controller/processor, a memory, or a combination thereof, of the UE described in connection with FIG. 2. In some aspects, the transmission component 2104 may be co-located with the reception component 2102 in a transceiver.

The communication manager 2106 may support operations of the reception component 2102 and/or the transmission component 2104. For example, the communication manager 2106 may receive information associated with configuring reception of communications by the reception component 2102 and/or transmission of communications by the transmission component 2104. Additionally, or alternatively, the communication manager 2106 may generate and/or provide control information to the reception component 2102 and/or the transmission component 2104 to control reception and/or transmission of communications.

In some aspects, the reception component 2102 may receive, from a network node, configuration information indicating that the UE is to measure N reference signals and report K reference signals, wherein N and K are integers. The transmission component 2104 may transmit, to the network node, a measurement report indicating a combination index associated with K selected reference signals of the N reference signals and measurement values for the K selected reference signals.

In some aspects, the reception component 2102 may receive, from a network node, configuration information indicating that the UE is to measure N reference signals and report K reference signals, wherein N and K are integers. The transmission component 2104 may transmit, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

In some aspects, the reception component 2102 may receive, from a network node, configuration information indicating a combination index that corresponds to N selected reference signals, from a set of M reference signals, to be measured by the UE, wherein N and M are integers. The transmission component 2104 may transmit, to the network node, a measurement report associated with measurements of the K selected reference signals.

In some aspects, the reception component 2102 may receive, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The transmission component 2104 may transmit, to the network node, a measurement report associated with measurements of the N selected reference signals.

In some aspects, the reception component 2102 may receive, from a network node, configuration information indicating one or more formats for indicating selected reference signals. The reception component 2102 and/or the transmission component 2104 may communicate with the network node based at least in part on the one or more formats for indicating selected reference signals.

The transmission component 2104 may transmit, to the network node, capability information indicating one or more supported formats for indicating selected reference signals, wherein the one or more formats for indicating selected reference signals are based at least in part on the capability information.

The communication manager 2106 may select the selected format of the plurality of formats based at least in part on report payload sizes associated with the plurality of formats for indicating selected reference signals.

The communication manager 2106 may determine payload sizes associated with the plurality of formats for indicating selected reference signals based at least in part on M and N.

The communication manager 2106 may determine the selected format used for the indication of the N selected reference signals based at least in part on the payload sizes associated with the plurality of formats for indicating selected reference signals.

The communication manager 2106 may determine the N selected reference signals to be measured by the UE based at least in part on the determination of the selected format used for the indication of the M selected reference signals.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

FIG. 22 is a diagram of an example apparatus 2200 for wireless communication, in accordance with the present disclosure. The apparatus 2200 may be a network node, or a network node may include the apparatus 2200. In some aspects, the apparatus 2200 includes a reception component 2202, a transmission component 2204, and/or a communication manager 2206, which may be in communication with one another (for example, via one or more buses and/or one or more other components). In some aspects, the communication manager 2206 is the communication manager 150 described in connection with FIG. 1. As shown, the apparatus 2200 may communicate with another apparatus 2208, such as a UE or a network node (such as a CU, a DU, an RU, or a base station), using the reception component 2202 and the transmission component 2204.

In some aspects, the apparatus 2200 may be configured to perform one or more operations described herein in connection with FIGS. 4-8, 9A-9B, and 10A-10C. Additionally, or alternatively, the apparatus 2200 may be configured to perform one or more processes described herein, such as process 1200 of FIG. 12, process 1400 of FIG. 14, process 1600 of FIG. 16, process 1800 of FIG. 18, process 2000 of FIG. 20, or a combination thereof. In some aspects, the apparatus 2200 and/or one or more components shown in FIG. 22 may include one or more components of the network node described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2208. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the network node described in connection with FIG. 2. In some aspects, the reception component 2202 and/or the transmission component 2204 may include or may be included in a network interface. The network interface may be configured to obtain and/or output signals for the apparatus 2200 via one or more communications links, such as a backhaul link, a midhaul link, and/or a fronthaul link.

The transmission component 2204 may transmit communications, such as reference signals, control information, data communications, or a combination thereof, to the apparatus 2208. In some aspects, one or more other components of the apparatus 2200 may generate communications and may provide the generated communications to the transmission component 2204 for transmission to the apparatus 2208. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2208. In some aspects, the transmission component 2204 may include one or more antennas, a modem, a modulator, a transmit MIMO processor, a transmit processor, a controller/processor, a memory, or a combination thereof, of the network node described in connection with FIG. 2. In some aspects, the transmission component 2204 may be co-located with the reception component 2202 in a transceiver.

The communication manager 2206 may support operations of the reception component 2202 and/or the transmission component 2204. For example, the communication manager 2206 may receive information associated with configuring reception of communications by the reception component 2202 and/or transmission of communications by the transmission component 2204. Additionally, or alternatively, the communication manager 2206 may generate and/or provide control information to the reception component 2202 and/or the transmission component 2204 to control reception and/or transmission of communications.

In some aspects, the transmission component 2204 may transmit, to a UE, configuration information indicating that the UE is to measure N reference signals and report K reference signals, wherein N and K are integers. The reception component 2202 may receive, from the UE, a measurement report indicating a combination index associated with K selected reference signals of the N reference signals and measurement values for the K selected reference signals.

In some aspects, the transmission component 2204 may transmit, to a UE, configuration information indicating that the UE is to measure N reference signals and report K reference signals, wherein N and K are integers. The reception component 2202 may receive, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

In some aspects, the transmission component 2204 may transmit, to a UE, configuration information indicating a combination index that corresponds to N selected reference signals, from a set of M reference signals, to be measured by the UE, wherein N and M are integers. The reception component 2202 may receive, from the UE, a measurement report associated with measurements of the N selected reference signals.

In some aspects, the transmission component 2204 may transmit, to a UE, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals. The reception component 2202 may receive, from the UE, a measurement report associated with measurements of the N selected reference signals.

In some aspects, the transmission component 2204 may transmit, to a UE, configuration information indicating one or more formats for indicating selected reference signals. The reception component 2202 and/or the transmission component 2204 may communicate with the UE based at least in part on the one or more formats for indicating selected reference signals.

The reception component 2202 may receive, from the UE, capability information indicating one or more supported formats for indicating selected reference signals, wherein the one or more formats for indicating selected reference signals are based at least in part on the capability information.

The communication manager 2206 may select the selected format of the plurality of formats based at least in part on payload sizes associated with the plurality of formats for indicating selected reference signals.

The communication manager 2206 may determine report payload sizes associated with the plurality of formats for indicating selected reference signals based at least in part on N and K.

The communication manager 2206 may determine the selected format used for indicating the K selected reference signals indicated in the measurement report based at least in part on the report payload sizes associated with the plurality of formats for indicating selected reference signals.

The communication manager 2206 may determine the K selected reference signals indicated in the measurement report based at least in part on the determination of the selected format used for the measurement report.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

The following provides an overview of some Aspects of the present disclosure:

Aspect 1: A method of wireless communication performed by a user equipment (UE), comprising: receiving, from a network node, configuration information indicating that the UE is to measure N reference signals and report K reference signals, wherein N and K are integers; and transmitting, to the network node, a measurement report indicating a combination index associated with K selected reference signals of the N reference signals and measurement values for the K selected reference signals.

Aspect 2: The method of Aspect 1, wherein the measurement report includes an indication of an index of a reference signal with a strongest measurement value among the K selected reference signals, and wherein the combination index indicates a combination of the K selected reference signals of the N reference signals.

Aspect 3: The method of Aspect 1-2, wherein the measurement report includes an indication of an index of a reference signal with a strongest measurement value among the N reference signals, and wherein the combination index indicates a combination of K−1 remaining selected reference signals, other than the reference signal with the strongest measurement value, of N−1 remaining reference signals other than the reference signal with the strongest measurement value.

Aspect 4: The method of any of Aspects 1-3, wherein the measurement values for the K selected reference signals include reference signal received power (RSRP) values or signal-to-interference-plus-noise (SINR) values for the K selected reference signals.

Aspect 5: The method of any of Aspects 1-4, wherein the measurement report indicates the measurement values for the K selected reference signals in ascending or descending order of respective reference signal indices associated with the K selected reference signals.

Aspect 6: The method of any of Aspects 1-4, wherein the measurement report indicates a strongest measurement value, among the measurement values for the K selected reference signals, first, followed by remaining measurement values, among the measurement values for the K selected reference signals in ascending or descending order of respective reference signal indices associated with the K selected reference signals.

Aspect 7: A method of wireless communication performed by a network node, comprising: transmitting, to a user equipment (UE), configuration information indicating that the UE is to measure N reference signals and report K reference signals, wherein N and K are integers; and receiving, from the UE, a measurement report indicating a combination index associated with K selected reference signals of the N reference signals and measurement values for the K selected reference signals.

Aspect 8: The method of Aspect 7, wherein the measurement report includes an indication of an index of a reference signal with a strongest measurement value among the K selected reference signals, and wherein the combination index indicates a combination of the K selected reference signals of the N reference signals.

Aspect 9: The method of Aspect 7, wherein the measurement report includes an indication of an index of a reference signal with a strongest measurement value among the N reference signals, and wherein the combination index indicates a combination of K−1 remaining selected reference signals, other than the reference signal with the strongest measurement value, of N−1 remaining reference signals other than the reference signal with the strongest measurement value.

Aspect 10: The method of any of Aspects 7-9, wherein the measurement values for the K selected reference signals include reference signal received power (RSRP) values or signal-to-interference-plus-noise (SINR) values for the K selected reference signals.

Aspect 11: The method of any of Aspects 7-10, wherein the measurement report indicates the measurement values for the K selected reference signals in ascending or descending order of respective reference signal indices associated with the K selected reference signals.

Aspect 12: The method of any of Aspects 7-10, wherein the measurement report indicates a strongest measurement value, among the measurement values for the K selected reference signals, first, followed by remaining measurement values, among the measurement values for the K selected reference signals in ascending or descending order of respective reference signal indices associated with the K selected reference signals.

Aspect 13: A method of wireless communication performed by a user equipment (UE), comprising: receiving, from a network node, configuration information indicating that the UE is to measure N reference signals and report K reference signals, wherein N and K are integers; and transmitting, to the network node, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Aspect 14: The method of Aspect 13, wherein the measurement report indicates a respective reference signal index value for a reference signal with a strongest measurement value among the K selected reference signals first, followed by respective reference signal index values for remaining reference signals, of the K selected reference signals, other than the reference signal with the strongest measurement value.

Aspect 15: The method of any of Aspects 13-14, wherein the measurement values for the K selected reference signals include reference signal received power (RSRP) values or signal-to-interference-plus-noise ratio (SINR) values for the K selected reference signals.

Aspect 16: A method of wireless communication performed by a network node, comprising: transmitting, to a user equipment (UE), configuration information indicating that the UE is to measure N reference signals and report K reference signals, wherein N and K are integers; and receiving, from the UE, a measurement report indicating measurement values for K selected reference signals of the N reference signals and respective reference signal index values for the K selected reference signals of the N reference signals, wherein a respective reference signal index value for an i-th selected reference signal of the K selected reference signals is determined from a set of N−i+1 remaining reference signals of the N reference signals.

Aspect 17: The method of Aspect 16, wherein the measurement report indicates a respective reference signal index value for a reference signal with a strongest measurement value among the K selected reference signals first, followed by respective reference signal index values for remaining reference signals, of the K selected reference signals, other than the reference signal with the strongest measurement value.

Aspect 18: The method of any of Aspects 16-17, wherein the measurement values for the K selected reference signals include reference signal received power (RSRP) values or signal-to-interference-plus-noise ratio (SINR) values for the K selected reference signals.

Aspect 19: A method of wireless communication performed by a user equipment (UE), comprising: receiving, from a network node, configuration information indicating a combination index that corresponds to N selected reference signals, from a set of M reference signals, to be measured by the UE, wherein N and M are integers; and transmitting, to the network node, a measurement report associated with measurements of the N selected reference signals.

Aspect 20: The method of Aspect 19, wherein the configuration information includes an indication of a value of N.

Aspect 21: The method of any of Aspects 19-20, wherein the measurement report indicates predicted measurement values for a set of beams based at least in part on the measurements of the N selected reference signals.

Aspect 22: The method of any of Aspects 19-21, wherein the measurement report indicates reference signal received power (RSRP) or signal-to-interference-plus-noise ratio (SINR) values associated with the measurements of the N selected reference signals.

Aspect 23: The method of any of Aspects 19-22, wherein the N selected reference signals are associated with a synchronization signal block (SSB) transmission pattern.

Aspect 24: The method of any of Aspects 19-23, wherein the measurement report indicates measurement values for K reference signals of the N selected reference signals, wherein K is an integer.

Aspect 25: A method of wireless communication performed by a network node, comprising: transmitting, to a user equipment (UE), configuration information indicating a combination index that corresponds to N selected reference signals, from a set of M reference signals, to be measured by the UE, wherein N and M are integers; and receiving, from the UE, a measurement report associated with measurements of the N selected reference signals.

Aspect 26: The method of Aspect 25, wherein the configuration information includes an indication of a value of N.

Aspect 27: The method of any of Aspects 25-26, wherein the measurement report indicates predicted measurement values for a set of beams based at least in part on the measurements of the N selected reference signals.

Aspect 28: The method of any of Aspects 25-27, wherein the measurement report indicates reference signal received power (RSRP) or signal-to-interference-plus-noise ratio (SINR) values associated with the measurements of the N selected reference signals.

Aspect 29: The method of any of Aspects 25-28, wherein the N selected reference signals are associated with a synchronization signal block (SSB) transmission pattern.

Aspect 30: The method of any of Aspects 25-29, wherein the measurement report indicates measurement values for K reference signals of the N selected reference signals, wherein K is an integer.

Aspect 31: A method of wireless communication performed by a user equipment (UE), comprising: receiving, from a network node, configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and transmitting, to the network node, a measurement report associated with measurements of the N selected reference signals.

Aspect 32: The method of Aspect 31, wherein the configuration information includes an indication of a value of N.

Aspect 33: The method of any of Aspects 31-32, wherein the measurement report indicates predicted measurement values for a set of beams based at least in part on the measurements of the N selected reference signals.

Aspect 34: The method of any of Aspects 31-33, wherein the measurement report indicates reference signal received power (RSRP) or signal-to-interference-plus-noise ratio (SINR) values associated with the measurements of the N selected reference signals.

Aspect 35: The method of any of Aspects 31-34, wherein the N selected reference signals are associated with a synchronization signal block (SSB) transmission pattern.

Aspect 36: The method of any of Aspects 31-35, wherein the measurement report indicates measurement values for K reference signals of the N selected reference signals, wherein K is an integer.

Aspect 37: A method of wireless communication performed by a network node, comprising: transmitting, to a user equipment (UE), configuration information indicating respective reference signal index values for N selected reference signals, from a set of M reference signals, to be measured by the UE, wherein N and M are integers, and wherein a respective reference signal index value for an i-th selected reference signal of the N selected reference signals is determined from a set of M−i+1 remaining reference signals of the M reference signals; and receiving, from the UE, a measurement report associated with measurements of the N selected reference signals.

Aspect 38: The method of Aspect 37, wherein the configuration information includes an indication of a value of N.

Aspect 39: The method of any of Aspects 37-38, wherein the measurement report indicates predicted measurement values for a set of beams based at least in part on the measurements of the N selected reference signals.

Aspect 40: The method of any of Aspects 37-39, wherein the measurement report indicates reference signal received power (RSRP) or signal-to-interference-plus-noise ratio (SINR) values associated with the measurements of the N selected reference signals.

Aspect 41: The method of any of Aspects 37-40, wherein the N selected reference signals are associated with a synchronization signal block (SSB) transmission pattern.

Aspect 42: The method of any of Aspects 37-41, wherein the measurement report indicates measurement values for K reference signals of the N selected reference signals, wherein K is an integer

Aspect 43: A method of wireless communication performed by a user equipment (UE), comprising: receiving, from a network node, configuration information indicating one or more formats for indicating selected reference signals; and communicating with the network node based at least in part on the one or more formats for indicating selected reference signals.

Aspect 44: The method of Aspect 43, further comprising: transmitting, to the network node, capability information indicating one or more supported formats for indicating selected reference signals, wherein the one or more formats for indicating selected reference signals are based at least in part on the capability information.

Aspect 45: The method of any of Aspects 43-44, wherein the configuration information indicates a configured format for indicating selected reference signals.

Aspect 46: The method of Aspect 45, wherein communicating with the network node comprises: transmitting, to the network node, a measurement report indicating K selected reference signals of N measured reference signals using the configured format for indicating selected reference signals, wherein K and N are integers.

Aspect 47: The method of any of Aspects 45-46, wherein communicating with the network node comprises: receiving, from the network node, an indication of N selected reference signals, of a set of M reference signals, to be measured by the UE, the indication of the N selected reference signals using the configured format for indicating selected reference signals, wherein N and M are integers.

Aspect 48: The method of any of Aspects 43-47, wherein the configuration information indicates a plurality of formats for indicating selected reference signals.

Aspect 49: The method of Aspect 48, wherein communicating with the network node comprises: transmitting, to the network node, a measurement report indicating K selected reference signals of N measured reference signals using a selected format of the plurality of formats for indicating selected reference signals, wherein K and N are integers.

Aspect 50: The method of Aspect 49, further comprising: selecting the selected format of the plurality of formats based at least in part on report payload sizes associated with the plurality of formats for indicating selected reference signals.

Aspect 51: The method of any of Aspects 49-50, wherein the selected format is a format associated with a smallest report payload size among the plurality of formats for indicating selected reference signals.

Aspect 52: The method of any of Aspects 49-41, wherein the measurement report includes an indication of the selected format of the plurality of formats for indicating selected reference signals.

Aspect 53: The method of any of Aspects 48-52, wherein communicating with the network node comprises: receiving, from the network node, an indication of N selected reference signals, of a set of M reference signals, to be measured by the UE, the indication of the N selected reference signals using a selected format of the plurality of formats for indicating selected reference signals, wherein N and M are integers.

Aspect 54: The method of Aspect 53, further comprising: determining payload sizes associated with the plurality of formats for indicating selected reference signals based at least in part on M and N; determining the selected format used for the indication of the N selected reference signals based at least in part on the payload sizes associated with the plurality of formats for indicating selected reference signals; and determining the N selected reference signals to be measured by the UE based at least in part on the determination of the selected format used for the indication of the N selected reference signals.

Aspect 55: The method of any of Aspects 53-54, wherein the indication of the N selected reference signals includes an indication of the selected format the plurality of formats for indicating selected reference signals.

Aspect 56: The method of any of Aspects 43-55, wherein the one or more formats for indicating selected reference signals include one or more of: a first format associated with a bitmap for indicating selected reference signals, a second format associated with indicating indices associated with selected reference signals, a third format associated with a combination index for indicating a combination of selected reference signals, a fourth format associated with machine learning compression of indices associated with selected reference signals, or a fifth format associated with Huffman coding of indices associated with selected reference signals.

Aspect 57: A method of wireless communication performed by a network node, comprising: transmitting, to a user equipment (UE), configuration information indicating one or more formats for indicating selected reference signals; and communicating with the UE based at least in part on the one or more formats for indicating selected reference signals.

Aspect 58: The method of Aspect 57, further comprising: receiving, from the UE, capability information indicating one or more supported formats for indicating selected reference signals, wherein the one or more formats for indicating selected reference signals are based at least in part on the capability information.

Aspect 59: The method of any of Aspects 57-58, wherein the configuration information indicates a configured format for indicating selected reference signals.

Aspect 60: The method of Aspect 59, wherein communicating with the UE comprises: receiving, from the UE, a measurement report indicating K selected reference signals of N measured reference signals using the configured format for indicating selected reference signals, wherein K and N are integers.

Aspect 61: The method of any of Aspects 59-60, wherein communicating with the UE comprises: transmitting, to the UE, an indication of N selected reference signals, of a set of M reference signals, to be measured by the UE, the indication of the N selected reference signals using the configured format for indicating selected reference signals, wherein N and M are integers.

Aspect 62: The method of any of Aspects 57-61, wherein the configuration information indicates a plurality of formats for indicating selected reference signals.

Aspect 63: The method of Aspect 62, wherein communicating with the UE comprises: transmitting, to the UE, an indication of N selected reference signals, of a set of M reference signals, to be measured by the UE, the indication of the N selected reference signals using a selected format of the plurality of formats for indicating selected reference signals, wherein N and M are integers.

Aspect 64: The method of Aspect 63, further comprising: selecting the selected format of the plurality of formats based at least in part on payload sizes associated with the plurality of formats for indicating selected reference signals.

Aspect 65: The method of any of Aspects 63-64, wherein the selected format is a format associated with a smallest payload size among the plurality of formats for indicating selected reference signals.

Aspect 66: The method of any of Aspects 63-65, wherein the indication of the K selected reference signals includes an indication of the selected format of the plurality of formats for indicating selected reference signals.

Aspect 67: The method of any of Aspects 62-66, wherein communicating with the UE comprises: receiving, from the UE, a measurement report indicating K selected reference signals of N measured reference signals using a selected format of the plurality of formats for indicating selected reference signals, wherein K and N are integers.

Aspect 68: The method of Aspect 67, further comprising: determining report payload sizes associated with the plurality of formats for indicating selected reference signals based at least in part on N and K; determining the selected format used for indicating the K selected reference signals indicated in the measurement report based at least in part on the report payload sizes associated with the plurality of formats for indicating selected reference signals; and determining the K selected reference signals indicated in the measurement report based at least in part on the determination of the selected format used for the measurement report.

Aspect 69: The method of any of Aspects 67-68, wherein the measurement report includes an indication of the selected format the plurality of formats for indicating selected reference signals.

Aspect 70: The method of any of Aspects 57-69, wherein the one or more formats for indicating selected reference signals include one or more of: a first format associated with a bitmap for indicating selected reference signals, a second format associated with indicating indices associated with selected reference signals, a third format associated with a combination index for indicating a combination of selected reference signals, a fourth format associated with machine learning compression of indices associated with selected reference signals, or a fifth format associated with Huffman coding of indices associated with selected reference signals.

Aspect 71: An apparatus for wireless communication at a device, comprising a processor; memory coupled with the processor; and instructions stored in the memory and executable by the processor to cause the apparatus to perform the method of one or more of Aspects 1-70.

Aspect 72: A device for wireless communication, comprising one or more memories and one or more processors coupled to the one or more memories, the one or more memories comprising instructions executable by the one or more processors to cause the device to perform the method of one or more of Aspects 1-70.

Aspect 73: A device for wireless communication, comprising one or more memories and one or more processors coupled to the one or more memories, the one or more processors configured to perform the method of one or more of Aspects 1-70.

Aspect 74: An apparatus for wireless communication, comprising at least one means for performing the method of one or more of Aspects 1-70.

Aspect 75: A non-transitory computer-readable medium storing code for wireless communication, the code comprising instructions executable by a processor to perform the method of one or more of Aspects 1-70.

Aspect 76: A non-transitory computer-readable medium storing a set of instructions for wireless communication, the set of instructions comprising one or more instructions that, when executed by one or more processors of a device, cause the device to perform the method of one or more of Aspects 1-70.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more memories including instructions executable by the one or more processors to cause the UE to:
receive, from a network node, configuration information indicating that the UE is to measure N reference signals and report K reference signals, wherein N and K are integers; and
transmit, to the network node, a measurement report indicating a combination index associated with K selected reference signals of the N reference signals and measurement values for the K selected reference signals.

2. The UE of claim 1, wherein the measurement report includes an indication of an index of a reference signal with a strongest measurement value among the K selected reference signals, and wherein the combination index indicates a combination of the K selected reference signals of the N reference signals.

3. The UE of claim 1, wherein the measurement report includes an indication of an index of a reference signal with a strongest measurement value among the N reference signals, and wherein the combination index indicates a combination of K−1 remaining selected reference signals, other than the reference signal with the strongest measurement value, of N−1 remaining reference signals other than the reference signal with the strongest measurement value.

4. The UE of claim 1, wherein the measurement values for the K selected reference signals include reference signal received power (RSRP) values or signal-to-interference-plus-noise (SINR) values for the K selected reference signals.

5. The UE of claim 1, wherein the measurement report indicates the measurement values for the K selected reference signals in ascending or descending order of respective reference signal indices associated with the K selected reference signals.

6. The UE of claim 1, wherein the measurement report indicates a strongest measurement value, among the measurement values for the K selected reference signals, first, followed by remaining measurement values, among the measurement values for the K selected reference signals in ascending or descending order of respective reference signal indices associated with the K selected reference signals.

7. A network node for wireless communication, comprising:
one or more memories; and
one or more processors coupled to the one or more memories, the one or more memories including instructions executable by the one or more processors to cause the network node to:
transmit, to a user equipment (UE), configuration information indicating a combination index that corresponds to N selected reference signals, from a set of M reference signals, to be measured by the UE, wherein N and M are integers; and
receive, from the UE, a measurement report associated with measurements of the N selected reference signals.

8. The network node of claim 7, wherein the configuration information includes an indication of a value of N.

9. The network node of claim 7, wherein the measurement report indicates predicted measurement values for a set of beams based at least in part on the measurements of the N selected reference signals.

10. The network node of claim 7, wherein the measurement report indicates reference signal received power (RSRP) or signal-to-interference-plus-noise ratio (SINR) values associated with the measurements of the N selected reference signals.

11. The network node of claim 7, wherein the N selected reference signals are associated with a synchronization signal block (SSB) transmission pattern.

12. The network node of claim 7, wherein the measurement report indicates measurement values for K reference signals of the N selected reference signals, wherein K is an integer.

13. A user equipment (UE) for wireless communication, comprising:
one or more memories; and
one or more processors coupled to the one or more memories, the one or more memories including instructions executable by the one or more processors to cause the UE to:
receive, from a network node, configuration information indicating one or more formats for indicating selected reference signals; and
communicate with the network node based at least in part on the one or more formats for indicating selected reference signals.

14. The UE of claim 13, wherein the one or more memories further include instructions executable by the one or more processors to cause the UE to:
transmit, to the network node, capability information indicating one or more supported formats for indicating selected reference signals, wherein the one or more formats for indicating selected reference signals are based at least in part on the capability information.

15. The UE of claim 13, wherein the configuration information indicates a configured format for indicating selected reference signals, and wherein the one or more memories include instructions executable by the one or more processors, to cause the UE to, when communicating with the network node, at least one of:
transmit, to the network node, a measurement report indicating K selected reference signals of N measured reference signals using the configured format for indicating selected reference signals, wherein K and N are integers; or
receive, from the network node, an indication of N selected reference signals, of a set of M reference signals, to be measured by the UE, the indication of the N selected reference signals using the configured format for indicating selected reference signals, wherein M is an integer.

16. The UE of claim 13, wherein the configuration information indicates a plurality of formats for indicating selected reference signals, and wherein the one or more memories include instructions executable by the one or more processors, to cause the UE to, when communicating with the network node:
transmit, to the network node, a measurement report indicating K selected reference signals of N measured reference signals using a selected format of the plurality of formats for indicating selected reference signals, wherein K and N are integers.

17. The UE of claim 16, wherein the one or more memories further include instructions executable by the one or more processors to cause the UE to:
select the selected format of the plurality of formats based at least in part on report payload sizes associated with the plurality of formats for indicating selected reference signals.

18. The UE of claim 16, wherein the measurement report includes an indication of the selected format of the plurality of formats for indicating selected reference signals.

19. The UE of claim 13, wherein the configuration information indicates a plurality of formats for indicating selected reference signals, and wherein the one or more memories include instructions executable by the one or more processors, to cause the UE to, when communicating with the network node:
receive, from the network node, an indication of N selected reference signals, of a set of M reference signals, to be measured by the UE, the indication of the N selected reference signals using a selected format of the plurality of formats for indicating selected reference signals, wherein N and M are integers.

20. The UE of claim 19, wherein the indication of the N selected reference signals includes an indication of the selected format the plurality of formats for indicating selected reference signals.
